(19) United States
(12) Patent Application Publication
(10) Pub. No.: US 2024/0374946 A1
(43) Pub. Date: Nov. 14, 2024

(54) VALVE ACTUATION SYSTEMS

(71) Applicant: Oxford Gas Products Limited, Harwell, Oxfordshire (GB)

(72) Inventors: Rupert Wilkinson, Harwell (GB); Andrew Roberts, Harwell (GB); Neil Robinson, Harwell (GB); Elanor Hobby, Harwell (GB)

(21) Appl. No.: 18/684,685

(22) PCT Filed: Aug. 18, 2022
(86) PCT No.: PCT/GB2022/052149

§ 371 Date: Feb. 18, 2024

(30) Foreign Application Priority Data
Aug. 18, 2021 (GB) 2111860.9

(51) Int. Cl. A62C 35/68; A62C 37/11; A62C 37/42

(52) U.S. Cl. CPC A62C 35/68; A62C 37/11; A62C 37/42

(57) ABSTRACT

An actuation system for a valve assembly is provided, the actuation system includes an actuation unit arranged to engage with an operating member of a valve to drive rotation of the operating member; and a remote actuation device arranged at a distance from the actuation unit and coupled to the actuation unit by an actuation cable, the actuation cable being operable to engage the actuation unit to drive rotation of the operating member; wherein the actuation system further includes an environmentally sensitive actuator arranged to operate the actuation cable; and wherein the remote actuation device includes a manual input element arranged to operate the actuation cable.

### TECHNICAL FIELD

The present invention relates to valve actuation systems, in particular systems that can be readily operated by a user remote from the valve and/or automatically in response to environmental conditions.

### BACKGROUND TO THE INVENTION

Emergency control valves (ECVs), such as those used on domestic gas supply lines, can be difficult to operate by lay people, especially those with physical disabilities.

Typical ECV shut-off arrangements, known in the art per se, generally require special modifications, e.g. to the valve, gas meter, gas infrastructure, etc. For example, some previous approaches to make operating an ECV easier have utilised a solenoid-based actuator. However, these are not generally easy to retro-fit to an existing installation. Moreover, a solenoid-based actuator, together with other actuators that require the use of electricity to actuate the ECV, may be considered unsuitable for many gas applications due to the risk of fire or explosion.

In various applications, more generally, it may be desirable to improve the ease of actuation for a valve in a fluid supply line. In many environments, it can be difficult even for a trained service person to access a valve and apply the necessary torque to close the valve. Remote actuation of valves is not known in the gas industry.

The present invention seeks to enable those with physical impairments to close off their gas ECV in case of emergency, without the use of electricity. Furthermore, the present invention seeks to assist with remote valve actuation across a range of applications.

### SUMMARY OF THE INVENTION

In accordance with a first aspect, the present invention provides an actuation system for a valve assembly, the actuation system comprising:
an actuation unit arranged to engage with an operating member of a valve to drive rotation of the operating member; and
a remote actuation device arranged at a distance from the actuation unit and coupled to the actuation unit by an actuation cable, the actuation cable being operable to engage the actuation unit to drive rotation of the operating member;
wherein the actuation system further includes an environmentally sensitive actuator arranged to operate the actuation cable (i.e. to engage the actuation unit to drive rotation of the operating member).

Thus it will be appreciated that embodiments of the present invention provide an improved actuation system in which operation of the valve (e.g. to close the valve) is capable of being triggered by the environmentally sensitive actuator operating the actuation cable without requiring any manual input. What is meant by the environmentally sensitive actuator “operating” the actuation cable is a mechanical operation. In other words, the environmentally sensitive actuator is arranged to mechanically operate the actuation cable, i.e. wherein a mechanical actuation force is transmitted via the actuation cable to the actuation unit. This conveniently ensures that the actuation system is purely mechanical. The actuation system being a non-electrical system makes it particularly suitable for use with gas valves. By way of example only, the actuation unit may be an EasyAssist® actuation unit.

In various examples, the actuation cable is connected at one end to a first triggering mechanism at the remote actuation device and connected at its other end to a second triggering mechanism at the actuation unit. The environmentally sensitive actuator may be arranged to operate the actuation cable via the first triggering mechanism. As is discussed further below, the remote actuation device may further include a manual input element that is also arranged to operate the actuation cable via the first triggering mechanism. At its other end, the actuation cable may be connected to a second triggering mechanism that engages with the operating member of the valve in any suitable to drive rotation thereof. There is described below an example wherein the second triggering mechanism comprises a torsion spring, a trigger member, and a driving member, the driving member being arranged to engage with the operating member of the valve to drive rotation of the operating member.

For example, the environmentally sensitive actuator may be a heat sensitive actuator (e.g. in the remote actuation device) which triggers the actuation cable operation when a threshold external temperature is reached. For example, a thermal fuse may be designed to fail within 30 seconds if subjected to a temperature of 93° C., such that operation of the actuation cable is triggered, automatically activating the operating member and shutting off the valve.

The environmentally sensitive actuator may be arranged to operate the actuation cable in response to an emergency situation. In various embodiments, the environmentally sensitive actuator is arranged to operate the actuation cable when activated by one or more of: heat, fire, smoke, pressure (e.g. from an explosion), vibration (e.g. from an earthquake), humidity, flood or freezing. Activation of the environmentally sensitive actuator by such environmental conditions allows automatic operation of the valve to the closed position without user input.

In a first set of embodiments, the environmentally sensitive actuator comprises a resettable element. For example, the environmentally sensitive actuator may comprise a resettable bimetallic element. The resettable bimetallic element may be bi-stable. A suitable bimetallic element may be pre-tensioned to change its shape (for example with a snap action) when exposed to temperatures above its designed operating temperature, ideally changing in a bi-stable manner. When the bimetallic element cools below its operating temperature then it returns to its original shape. In another example, the environmentally sensitive actuator may comprise a resettable shape memory alloy element. Such examples are well-suited to the actuation system as their shape change can be directly applied as a mechanical force to operate the actuation cable.

In a second set of embodiments, the environmentally sensitive actuator comprises a sacrificial element. The sacrificial element may, for example, comprise a component that dissolves in a flood or melts in a fire. Additionally or alternatively, the sacrificial element may be arranged to physically break in response to environmental conditions, e.g. the pressure wave of an explosion.

In some examples, the sacrificial element may be frangible. For example, the sacrificial element comprises a glass bulb. The temperature threshold of the bulb may, for example, depend on the geometry of the bulb and/or a fluid composition within the bulb (e.g. a liquid and/or gas inside the bulb that expands when exposed to sufficient heat energy). The Applicant has appreciated that it is advantageous to use a frangible glass bulb (similar to frangible glass bulbs used in fire sprinkler systems) in order to provide a heat-activated actuator, e.g. to close a gas supply valve in the event of a fire.

In addition to the environmentally sensitive actuator being activated automatically, it may also be arranged to operate the actuation cable when overpowered with a particular input force, e.g. activated manually in an override mode. The remote actuation device can provide an additional, more convenient way of triggering the actuation unit (which typically has its own remote trigger member)-notably when direct access to the actuation unit or valve is problematic, awkward or not pragmatic, or the end user is in a vulnerable situation.

In some embodiments, the valve is a gas supply valve and the environmentally sensitive actuator is arranged to operate the actuation cable in response to one or more of: elevated heat, elevated pressure (e.g. explosion), fire, or smoke. In these embodiments, the actuation cable is operable to engage the actuation unit to drive rotation of the operating member to a closed position (i.e. gas supply shut-off). In some embodiments, the valve is a water supply valve and the environmentally sensitive actuator is arranged to operate the actuation cable in response to flood or freezing conditions. In these embodiments, the actuation cable is operable to engage the actuation unit to drive rotation of the operating member to a closed position (i.e. water supply shut-off).

In some other embodiments, the valve is a water control valve and the environmentally sensitive actuator is arranged to operate the actuation cable in response to one or more of: elevated heat, elevated pressure (e.g. explosion), fire, or smoke. In these embodiments, the actuation cable is operable to engage the actuation unit to drive rotation of the operating member to an open position (i.e. to turn on the water supply) e.g. in a fire protection system such as a water sprinkler system.

In any of the embodiments described above, the remote actuation device may include a manual input element arranged to operate the actuation cable (i.e. to engage the actuation unit to drive rotation of the operating member). Thus a user has the option of proactively operating the actuation cable to operate the valve remotely, e.g. to close the valve without being close to the actuation unit. In various embodiments, the actuation cable may have a length between 0.5 and 5 metres, for example between 1 and 4 metres, for example between 1 and 3 metres, for example between 1 and 2 metres.

A benefit of the remote actuation device including a manual input element arranged to operate the actuation cable, in addition to the environmentally sensitive actuator, is that the actuation mechanism is common to both types of trigger. The actuation cable can be operated (that is, by the manual input element) to release the operating member (e.g. by engaging the actuation unit to drive rotation of the operating member) independently of activation of the environmentally sensitive actuator. In various embodiments, described further below, the actuation cable may be operated multiple times by the manual input element with the remote activation/actuation device being reset after each operation.

In some embodiments, the environmentally sensitive actuator is arranged between the remote actuation device and the actuation unit. The environmentally sensitive actuator may comprise an in-line resettable element or an in-line sacrificial element. Activation of this in-line element is independent of any manual input at the remote device to operate the actuation cable. The flexibility of the actuation cable and its positioning may enable the in-line element to be better placed to respond to environmental conditions than the remote actuation device or the actuation unit.

In some embodiments, the actuation cable includes an in-line sacrificial element module. A benefit of such embodiments is that the in-line module can be replaced following activation without affecting the remote actuation device or actuation unit. Preferably the in-line sacrificial element module is a replaceable module. In one such example, the sacrificial element (e.g. heat-sensitive bulb) is arranged in the in-line module to separate two C-shaped components which are sprung together and the actuation cable is connected either side of the C-shaped components. When the sacrificial element fails, the C-shaped components spring together, which pulls on the actuation cable. The actuation cable is therefore operated to act on the valve, e.g. to automatically close a gas valve upon sensing heat.

In some embodiments, the in-line environmentally sensitive actuator module comprises a visual indicator arranged to indicate when the valve is in the open position and when the valve is in the closed position following operation of the environmentally sensitive actuator, optionally wherein a first visual marker (“ON” sign) indicates the open position and a second visual marker (“OFF” sign) indicates the closed position.

In some embodiments, the environmentally sensitive actuator is integrated with the actuation cable. In those embodiments wherein the environmentally sensitive actuator comprises a sacrificial element, the actuation cable may itself be the sacrificial element. In such embodiments, the actuation cable includes the environmentally sensitive actuator such that the actuation cable is arranged to operate itself in response to environmental conditions. For example, the actuation cable may comprise a sacrificial component and be pre-tensioned to prevent the operating member from driving rotation of the operating member for the valve, wherein failure of the sacrificial component removes the pre-tensioning from the cable such that the actuation unit becomes engaged to drive rotation of the operating member, e.g. to close the valve.

In some embodiments, the remote actuation device includes the environmentally sensitive actuator arranged to operate the actuation cable. The environmentally sensitive actuator may be arranged to operate the actuation cable directly or indirectly. In a set of embodiments, the remote actuation device comprises a remote trigger member coupled to an end of the actuation cable and arranged to be operated by the environmentally sensitive actuator. In those embodiments wherein the remote actuation device comprises a manual input element, the remote trigger member may be arranged to be operated by the manual input element as well (or alternatively). For example, the remote actuation device may comprise a spring arranged to bias the remote trigger member to operate the actuation cable, wherein the environmentally sensitive actuator is arranged to hold the remote trigger member against the bias. When the environmentally sensitive actuator is activated, the spring is free to bias the remote trigger member and thereby operate the actuation cable. Furthermore, in at least some such embodiments, the remote actuation device includes a manual input element (e.g. push button or switch) which is also be arranged to act independently on the remote trigger member. This minimises the number of components connected to the actuation cable for common operation. This reduces the tolerance stack-up in the device, which will increase the accuracy and reliability of the device.

In some examples, the remote trigger member comprises a slideable member. In some examples, the remote trigger member comprises a rotatable member. In some examples, the remote trigger member comprises a rotatable member that is arranged to rotate around an axis and arranged to move linearly along the axis. For example, the remote actuation device may comprise a spring arranged to bias the remote trigger member to rotate to operate the actuation cable, wherein the environmentally sensitive actuator is arranged as a stop to hold the remote trigger member against the bias, and wherein the remote actuation device includes a manual input element arranged to move the rotatable member along the axis away from the stop. When either the environmentally sensitive actuator or manual input element is activated, the remote trigger member is free from the stop and the spring acts to bias rotation of the remote trigger member, which thereby operates the actuation cable to engage the actuation unit to drive rotation of the operating member, e.g. to close the valve.

In various examples wherein the remote actuation device comprises a spring arranged to bias the remote trigger member to operate the actuation cable, the spring may be a single compression/tension spring, a pair of compression/tension springs e.g. arranged either side of the remote trigger member, or a combined torsion and compression/tension spring.

In an example, the remote trigger member may comprise a first moveable (e.g. slideable) member (e.g. an outer sliding carriage) acted on by the spring bias and a second moveable (e.g. slideable) member (e.g. an inner sliding carriage) moveable relative to the first moveable member, with the manual input element arranged to act on the second moveable member independently of the first moveable member. The second moveable (e.g. slideable) member can be coupled to the end of the actuation cable, such that a manual force (e.g. pushing down) on the manual input element causes lateral movement of the second moveable member to operate the actuation cable. The first moveable (e.g. slideable) member may also be coupled to the end of the actuation cable, such that activation of the environmentally sensitive actuator releases the first moveable (e.g. slideable) member to be acted on by the spring bias to operate the actuation cable.

In an example, the first and second moveable (e.g. slideable) members can move independently of one another. In an example, the first and second moveable (e.g. slideable) members are coupled together, e.g. such that they both move when either the manual input element or the environmentally sensitive actuator triggers operation of the actuation cable. This means that, optionally, only one of the first or second moveable members needs to be coupled to an end of the actuation cable. This also means that the manual input element may be pulled down when the first moveable (e.g. slideable) member is triggered by activation of the environmentally sensitive actuator, giving a visual and/or tactile indication that the remote actuation device has been automatically triggered.

Furthermore, in examples including an indicator, this may be coupled to the first and/or second moveable member to display that the valve is being operated by the actuation cable (whether activated manually or automatically).

In another example, the remote trigger member may comprise a first moveable (e.g. rotatable) member coupled to a second moveable (e.g. rotatable) member, wherein the first rotatable member is arranged to move along the axis of the manual input element (e.g. a manual input button pushes the first rotatable member along its axis) to decouple from the second rotatable member and rotate around the axis under a spring bias to operate the actuation cable, e.g. in a manual activation mode. In this example, the second rotatable member may also be coupled to the environmentally sensitive actuator such that activation of the environmentally sensitive actuator releases the second rotatable member rotate around the axis under a spring bias (from the same spring and/or another spring) to operate the actuation cable, e.g. in an automatic activation mode. As the first moveable member is coupled to the second moveable member, the two members rotate together. This means that only the first moveable member needs to be coupled to an end of the actuation cable. Furthermore, in examples including an indicator, this may be coupled to the first moveable member to display that the valve is being operated (whether activated manually or automatically). This example provides a particularly compact form for the remote actuation unit, as the remote trigger member comprises rotatable members arranged around the axis of the manual input element (preferably a push button).

In a set of potentially overlapping embodiments, the manual input element is coupled to the remote trigger member such that operation of the remote trigger member by the environmentally sensitive actuator also moves the manual input element. This means that the manual input element (e.g. button or switch) can be pulled down automatically if automatic activation occurs, providing a visual and tactile indication to a remote user that the valve is being closed. Optionally the manual input element is locked in this OFF state until the valve is opened and the environmentally sensitive actuator is reset or replaced. For example, the manual input element may be coupled to the remote trigger member by an over-centre linkage mechanism.

In a set of embodiments, the remote actuation device comprises a spring arranged to translate the remote trigger member to operate the actuation cable and a stop to prevent translation of the remote trigger member. Optionally the stop comprises the environmentally sensitive actuator. The manual input element may be coupled to the remote trigger member such that pressing down the manual input element in a first direction releases the remote trigger member from the stop to allow translation of the remote trigger member in a second (e.g. perpendicular) direction. In these examples, the manual input element may be coupled to the remote trigger member such that pulling up the manual input element acts to reset the remote trigger member and bias the spring. In addition, or alternatively, a force (e.g. push) transmitted by the actuation cable from the actuation unit can reset the remote trigger member, e.g. when the actuation unit is reset manually at the other end of the cable.

In a set of embodiments, the remote actuation device comprises a spring arranged to rotate the remote trigger member around an axis to operate the actuation cable and a stop to prevent rotation of the remote trigger member. Optionally the stop comprises the environmentally sensitive actuator. The manual input element may be coupled to the remote trigger member such that pressing down the manual input element in the direction of the axis releases the remote trigger member from the stop to allow spring-biased rotation of the trigger member. In these examples, the manual input element may be coupled to the remote trigger member such that rotating the manual input element around the axis acts to reset the remote trigger member and bias the spring. In addition, or alternatively, a force (e.g. push) transmitted by the actuation cable from the actuation unit can reset the remote trigger member, e.g. when the actuation unit is reset manually at the other end of the cable.

It has been appreciated that it can be particularly convenient and intuitive for a user to press a manual input element at the remote actuation device in order to trigger operation of the actuation cable (or any other actuation linkage), with a rotational (rather than translational) movement being generated to operate the actuation cable or linkage. This can help to keep the remote actuation device compact in form.

In accordance with another aspect, the present invention provides an actuation system for a valve assembly, the actuation system comprising:
an actuation unit arranged to engage with an operating member of a valve to drive rotation of the operating member; and
a remote actuation device arranged at a distance from the actuation unit and coupled to the actuation unit by an actuation cable or linkage, the actuation cable or linkage being operable to engage the actuation unit to drive rotation of the operating member;
wherein the remote actuation device includes a manual input element and a remote trigger mechanism arranged to operate the actuation cable (i.e. to engage the actuation unit to drive rotation of the operating member);
wherein the manual input element is a push button and the remote trigger mechanism is arranged to convert an axial movement of the push button into a rotational movement that operates the actuation cable or linkage.

In various embodiments according to this aspect, the remote actuation device may be coupled to the actuation unit by any suitable type of actuation cable or linkage. For example, the actuation linkage may comprise one or more of a mechanical linkage, flexible drive shaft, pneumatic linkage or hydraulic linkage. For example, the actuation cable may comprise a force transmission cable, preferably a two-way force transmission cable, such as a Bowden cable. A suitable actuation cable may comprise an inner cable that is moveable relative to a hollow outer cable housing.

In various embodiments according to this aspect, the remote trigger mechanism comprises a remote trigger member and a spring arranged to bias rotation of the remote trigger member around an axis to operate the actuation cable. In some examples, the remote trigger mechanism comprises a stop arranged to prevent rotation of the remote trigger member under the spring bias. Optionally the stop comprises an environmentally sensitive actuator, for example a sacrificial element. The manual input element may be coupled to the remote trigger member such that pushing down the manual input element in the direction of the axis releases the remote trigger member from the stop to allow spring-biased rotation of the trigger member. This means that the trigger member rotates to operate the actuation cable or linkage upon either manual input or action of the environmentally sensitive actuator.

In various embodiments of any aspect including a remote trigger member and a spring arranged to move (e.g. by rotation or translation) the remote trigger member to operate the actuation cable, the spring (e.g. angled tension spring or combined torsion and compression spring) may be coupled to the remote trigger member such that, when the remote trigger member is reset to bias the spring, the spring also applies a force to push up the manual input element (e.g. a force along the axis of the rotatable trigger member to push up the manual input element). In some examples, the spring (e.g. angled tension spring or combined torsion and compression spring or multiple springs) directly acts on the manual input element to apply the force (e.g. to push up the button). In some examples, the spring (e.g. straight tension or compression spring) indirectly acts on the manual input element, e.g. via a mechanical (e.g. pivoting) linkage, to apply the force (e.g. to push up the button). In some examples, a combination of spring(s) and mechanical linkage(s) may be arranged to apply a force to push up the manual input element when the remote trigger member is reset to bias the spring.

In various embodiments, the actuation cable is a force transmission cable. A suitable actuation cable may comprise an inner cable that is moveable relative to a hollow outer cable housing. Those skilled in the art will appreciate that a Bowden cable (sometimes colloquially referred to as a ‘brake cable’) is an example of a flexible cable that can transmit a pulling force from one end of the cable to the other. In various embodiments, the actuation cable is a two-way force transmission cable, i.e. a pull and push cable. Flexible push/pull Bowden cables of this type typically comprise a solid wire rather than an inner cable.

In a set of potentially overlapping embodiments, the remote actuation device comprises the remote trigger member and a remote indicator coupled to the remote trigger member. When the environmentally sensitive actuator (or manual input element, where included) acts to operate the remote trigger member, the valve is operated and the valve state is indicated at the remote indicator, e.g. a change from valve ON to valve OFF may be displayed or otherwise indicated (visually, audibly, haptic feedback, etc.). Thus, in some embodiments, the remote actuation device comprises a visual indicator coupled to the remote trigger member to remotely indicate when the valve is in the open position and when the valve is in the closed position, optionally wherein a first visual marker (“ON” sign) indicates the open position and a second visual marker (“OFF” sign) indicates the closed position.

More generally, the remote indicator may respond to operation of the actuation cable regardless of whether a remote trigger member is provided or not. In a set of potentially overlapping embodiments, the remote actuation device comprises a remote indicator coupled (e.g. directly, e.g. indirectly) to the actuation cable such that operation of the actuation cable (i.e. to engage the actuation unit to drive rotation of the operating member, i.e. to release the operating member) changes the valve status at the remote indicator. For example, the valve status at the remote indicator may be changed from ON to OFF upon operation of the actuation cable. In addition, or alternatively, the remote indicator may be coupled (e.g. directly, e.g. indirectly) to the actuation cable such that reverse operation of the actuation cable upon reset of the valve operating member changes the valve status at the remote indicator. For example, the valve status at the remote indicator may be changed from OFF to ON upon reverse operation of the actuation cable.

In a set of potentially overlapping embodiments, the actuation cable is arranged to transmit a reset force to the remote actuation device to reset the manual input element when the valve at the actuation unit is reset. In embodiments wherein the actuation device comprises a remote trigger member, the actuation cable may be arranged to transmit a reset force to the remote actuation device to reset the remote trigger member when the valve at the actuation unit is reset. Preferably, resetting the remote trigger member also resets the manual input element without affecting the environmentally sensitive actuator.

In the various embodiments described above, the remote actuation device will enable an actuation unit (such as, by way of example only, an EasyAssist® actuation unit) to be triggered remotely, at a distance from the valve. This will allow a trigger to be placed in a more accessible and convenient place for people who might have difficulty accessing it otherwise. The customer may be able to see the status of the valve from the remote actuation device. It is envisaged that the actuation cable will be robust enough to withstand installation in a domestic setting and accommodate multiple ‘actuations’. There is currently no remote actuation device on the market for particular use within the gas sector to shut off a gas supply valve.

In any of the embodiments described herein, where the remote actuation device is arranged at a distance from the actuation unit, it will be understood that the remote actuation device is in a different physical location to the actuation unit (and hence to the valve being operated), such that the remote actuation device may be more accessible than the actuation unit. As mentioned above, the actuation cable may have a length between 0.5 and 5 metres, for example between 1 and 4 metres, for example between 1 and 3 metres, for example between 1 and 2 metres. In some preferred embodiments, the actuation system is installed with the remote actuation device located within 2 metres of the actuation unit. The remote actuation device may be located in an accessible position outside a meter box containing the valve.

In a set of potentially overlapping embodiments, the remote actuation device comprises a remote indicator coupled to the manual input element. When the manual input element is operated to remotely trigger the actuation unit, the valve state is indicated at the remote indicator, e.g. a change from valve ON to valve OFF may be displayed or otherwise indicated (visually, audibly, haptic feedback, etc.). Thus, in some embodiments, the remote actuation device comprises a visual indicator coupled to the manual input element and/or its locking mechanism, to remotely indicate when the valve is in the open position and when the valve is in the closed position. Optionally, a first visual marker (“ON” sign) indicates the open position and a second visual marker (“OFF” sign) indicates the closed position.

In various embodiments, the remote actuation device comprises a housing and the manual input element (e.g. button/switch) is arranged in the housing for ease of use. The form and shape of the housing and/or manual input element may be designed to discourage accidental triggering. For example, the manual input element may be recessed to prevent accidental triggering.

The embodiments described above may apply to any actuation system comprising a remote actuation device arranged at a distance from and coupled to an actuation unit by an actuation linkage, where the actuation linkage comprises one or more of a cable, mechanical linkage, flexible drive shaft, pneumatic linkage or hydraulic linkage, for example. Such a remote actuation device may optionally include a sacrificial element according to some of the embodiments described above. If the sacrificial element is activated then it is usually necessary for it to be replaced before the system can be used again. Even for a resettable element, manual intervention may be needed to reset the environmentally sensitive actuator before the system can be used again. A convenient way to ensure that the system is serviced before the valve can be turned back on is for the manual input means to be automatically disabled upon activation of the environmentally sensitive actuator.

In any of the embodiments described herein, the remote actuation device may further comprise a sensor module for detecting movement of the actuation cable (either directly or via the remote trigger member) between a first state corresponding to the actuation cable being unoperated and a second state corresponding to the actuation cable being operated. Optionally, the sensor module is configured to detect a third state between the first state and the second state, for example indicating that the cable has not been fully operated. In these embodiments, the remote actuation device may further comprise a communications module for transmitting status information relating to the detected state, e.g. the first and/or second state (and optionally the third state). The communications module may be wired or wireless. Preferably the communications module comprises a radio communications module, e.g. WiFi, Bluetooth, GSM, etc. This can enable the remote actuation device to be in communication with the owner of the gas distribution network or gas network service company.

For example, the communications module may be arranged to transmit ON status when the detected state is the first position corresponding to the actuation cable being unoperated. For example, the communications module may be arranged to transmit OFF status when the detected state is the second position corresponding to the actuation cable being operated. For example, the communications module may be arranged to transmit an ERROR status when the detected state is the third state corresponding to any other position. Although the ON/OFF status is directly detected for the actuation cable at the remote actuation device, it may be assumed that this reflects the ON/OFF status of the valve being operated by the actuation cable. Such a communications module may be used to transmit valve open/closure events to a call centre.

Even without a communications module, or in addition thereto, the remote actuation device may comprise a remote indicator for displaying status information relating to the detected state e.g. first and/or second state (and optionally the third state). This may be a visual indicator as already described. In some examples, the visual indicator may be integrated with, or coupled to, the manual input element. In some examples, the visual indicator may be integrated with, or coupled to, the remote trigger member. This remote indicator may be instead of, or as well as, a remote indicator as already described that is coupled to the actuation cable and/or remote trigger member.

In a set of potentially overlapping embodiments, the remote actuation device includes a locking mechanism arranged to disable the manual input element when the environmentally sensitive actuator is activated to operate the actuation cable, e.g. to open the valve via the actuation unit. This can provide a tactile feedback to a user that the valve is in the OFF state, which may be particularly helpful if the remote actuation device is positioned such that its indicator or display is not visible. It has been appreciated that this feedback at the remote actuation device can be beneficial regardless of whether the environmentally sensitive actuator is part of the remote actuation device or the actuation unit.

In accordance with another aspect, the present invention provides an actuation system for a valve assembly, the actuation system comprising:
an actuation unit arranged to engage with an operating member of a valve to drive rotation of the operating member; and
a remote actuation device arranged at a distance from the actuation unit and coupled to the actuation unit by an actuation linkage, the actuation linkage being operable to allow the operating member to drive rotation of the operating member;
wherein the remote actuation device includes a manual input element arranged to operate the actuation linkage;
the system further comprising an environmentally sensitive actuator arranged to allow engagement of the actuation unit to drive rotation of the operating member upon its activation, and a locking mechanism arranged to disable the manual input element when the environmentally sensitive actuator is activated.

In these embodiments, the locking mechanism disables the manual input element of the remote actuation device upon activation of the environmentally sensitive actuator, to help make users aware that automatic activation has taken place and action may be required to reset the system. For example, when a manual input button is disabled (e.g. depressed) then a user can see and feel that the remote actuation device needs attention. This may prompt reset or replacement of the environmentally sensitive actuator, or its associated module, or even the whole remote actuation device.

In at least some embodiments, the manual input element remains depressed until a reset force is transmitted by the actuation linkage to release the locking mechanism. For example, when the valve is re-opened the actuation unit may be arranged to transmit the reset force via the actuation linkage to release the locking mechanism and re-enable the manual input element. A user at the remote activation device has a visual and tactile indication confirming the ON or OFF state of the valve. The manual input element may be coupled to a remote indicator as described above.

In a first set of embodiments, the remote actuation device comprises the environmentally sensitive actuator, for example arranged to operate the actuation cable and thereby engage the actuation unit to drive rotation of the operating member, according to any of the embodiments as described above. In at least some examples, the environmentally sensitive actuator comprises a sacrificial element.

In a second set of embodiments, the actuation unit comprises the environmentally sensitive actuator, for example arranged to allow engagement of the actuation unit to drive rotation of the operating member only upon its activation (e.g. by releasing a latching mechanism in the actuation unit). In at least some examples, the environmentally sensitive actuator comprises a sacrificial element.

In those embodiments wherein the actuation unit comprises the environmentally sensitive actuator, it has been appreciated that there is a benefit to coupling the actuation unit to a remote actuation device by an appropriate linkage. The remote actuation device may include its own environmentally sensitive actuator as well. In various actuation systems, it may only be necessary to include a single manual input element. It is conventional to include a manual input element or manual trigger at the actuation unit to ensure that local operation of the valve is always possible. However, it has now been appreciated that some valves and actuation units may be positioned in such a hard-to-reach place that the only feasible way to provide manual activation is by coupling the actuation unit to a remote actuation device arranged at a distance from the actuation unit, for example with an actuation linkage as described above. In such embodiments, it may still be desirable for the actuation unit to include an environmentally sensitive actuator. Fewer parts and less complexity may be involved if the environmentally sensitive actuator is coupled to the actuation linkage for manual activation in addition to its own automatic activation.

In accordance with another aspect, the present invention provides an actuation system for a valve assembly, the actuation system comprising:
an actuation unit arranged to engage with an operating member of a valve to drive rotation of the operating member; and
a remote actuation device arranged at a distance from the actuation unit and coupled to the actuation unit by an actuation linkage, the actuation linkage being operable to allow the operating member to drive rotation of the operating member;
wherein the remote actuation device includes a manual input element arranged to operate the actuation linkage;
the actuation unit further comprising an environmentally sensitive actuator arranged to allow engagement of the actuation unit to drive rotation of the operating member upon its activation, wherein the environmentally sensitive actuator can be activated by operation of the actuation linkage.

Thus it will be appreciated that in these embodiments the environmentally sensitive actuator at the actuation unit can be activated in two different ways—its own automatic activation or activation caused by operation of the actuation linkage. This means the same mechanism components are used for both automatic activation (e.g. in response to environmental condition) and remote manual actuation. This reduces the number of components in the actuation unit. For example, the environmentally sensitive actuator may be a resettable or sacrificial element that is physically forced to activate by operation of the actuation linkage (e.g. over-centre movement of a bimetallic actuator, e.g. breakage of a glass bulb). As mentioned above, the environmentally sensitive actuator can be activated by one or more of: heat, fire, smoke, pressure (e.g. from an explosion), vibration (e.g. from an earthquake), humidity, flood or freezing. In various of these embodiments, the actuation unit may not include a manual trigger at all.

In various of the embodiments described above, when operation of the actuation cable or linkage is initiated away from the actuation unit (e.g. at the remote actuation device, e.g. in-line with actuation cable or linkage) it is assumed that this operation acts to engage the actuation unit to drive rotation of the operating member of the valve, i.e. to open or close the valve. Any remote indicator is assumed to reflect the valve status. However, it has been appreciated that this may not be totally reliable, for example if operation the actuation cable or linkage fails to fully rotate the operating member e.g. so that the valve is not fully closed or opened as expected. A more reliable way of checking the true valve status, in addition or alternatively, is to include a sensing arrangement in the actuation unit itself.

In a set of potentially overlapping embodiments, the actuation unit comprises a valve status sensor configured to detect a rotational position of the operating member. Furthermore, the actuation unit may comprise a valve status indicator arranged to display the valve status in response to the detected rotational position of the operating member. For example, when the valve status sensor detects that the rotational position corresponds to open/closing/closed then the valve status indicator may display ON/ON/OFF. This means that an OFF status is only displayed once the operating member has fully rotated e.g. through a quarter turn for a ball valve. In at least some such embodiments, the actuation unit comprises a communications module for transmitting valve status information relating to the rotational position of the operating member.

It has also been appreciated that it can be critical for a person to be able to find either the remote actuation device, or the actuation unit itself, quickly e.g. in an emergency situation. In a set of potentially overlapping embodiments, the actuation unit and/or the remote actuation device comprises a location module connected to a/the communications module for transmitting location information relating to its physical position. For example, the location module may comprise a location sensor such as a GPS receiver and/or a memory programmed with location information.

In a set of potentially overlapping embodiments, the actuation unit and/or the remote actuation device comprises a location module configured to generate a visible and/or audible signal, for example an alarm or a flashing light. The visible and/or audible signal may be activated remotely. In some examples, the location module is connected to a/the communications module for receiving an activation signal that generates the visible and/or audible signal. The activation signal may be sent from a remote call centre or a user's computing device. The visible and/or audible signal advantageously aids a user in locating the remote actuation device and/or the actuation unit, and is particularly useful for the visually or hearing impaired.

In accordance with another aspect, the present invention provides an actuation unit for a valve assembly, the actuation unit comprising a torsion spring, a trigger member, and a driving member, said driving member being arranged to engage with an operating member of a valve to drive rotation of the operating member, wherein the torsion spring applies a first torque to the driving member around the axis in a first rotational direction;
wherein an external second torque applied opposite to the first torque resets the valve to an open position in which the driving member is held by a latching mechanism, thereby resisting the first torque of the torsion spring, said latching mechanism being arranged to hold the driving member only when the valve is in the open position;
wherein an external force applied to the trigger member releases the driving member such that it is no longer held by the latching mechanism, the first torque thereby rotating the driving member in the first rotational direction so as to drive rotation of the operating member and mechanically bias the valve to the closed position; and
wherein the actuation unit further includes a location module connected to a/the communications module for transmitting location information relating to its physical position.

In various of the embodiments described above, the actuation unit and/or the remote actuation device may comprise a/the communications module connected to a remote computer. This means that the remote computer (e.g. at a call centre, gas service network operator or user's mobile phone) can receive information relating to status and/or location.

The embodiments described above relate to remote actuation of an actuation unit. However, the Applicant has appreciated that it may be beneficial for an actuation unit to trigger itself automatically in response to an emergency, in addition to being connected to a remote actuation device or even without connection to a remote actuation device. An issue with the use of sacrificial elements is that they may require replacement of several parts, or even of the whole actuation system, before the valve can be safely reset. This causes downtime and can be costly. Even without being sacrificial, the environmentally sensitive actuator may deteriorate over time and require replacement. In any of the embodiments described above, it is preferable that the environmentally sensitive actuator is housed in a removable and/or replaceable module.

In accordance with another aspect, the present invention provides an actuation unit for a valve assembly, the actuation unit comprising a torsion spring, a trigger member, and a driving member, said driving member being arranged to engage with an operating member of a valve to drive rotation of the operating member, wherein the torsion spring applies a first torque to the driving member around the axis in a first rotational direction;
wherein an external second torque applied opposite to the first torque resets the valve to an open position in which the driving member is held by a latching mechanism, thereby resisting the first torque of the torsion spring, said latching mechanism being arranged to hold the driving member only when the valve is in the open position;
wherein an external force applied to the trigger member releases the driving member such that it is no longer held by the latching mechanism, the first torque thereby rotating the driving member in the first rotational direction so as to drive rotation of the operating member and mechanically bias the valve to the closed position; and
wherein the actuation unit further includes an environmentally sensitive actuator arranged to release the latching mechanism, wherein the environmentally sensitive actuator is located in a replaceable module.

The module can be removed to replace the environmentally sensitive actuator, without replacing the entire actuation unit. When the environmentally sensitive actuator comprises a sacrificial element (e.g. glass bulb) that breaks upon activation, the debris is contained in the module and can be disposed of easily without affecting other components of the actuation unit. In some embodiments, the removable module is threaded so that it can be easily fitted to the actuation unit and removed. Furthermore, a threaded fitting gives some adjustability in the exact location of the environmentally sensitive actuator, to account for manufacturing tolerance e.g. in glass bulbs. This adjustability ensures the environmentally sensitive actuator couples effectively with the latching mechanism which holds the driving member in place.

The environmentally sensitive actuator may be arranged in any suitable way to release the driving member such that it is no longer held by the latching mechanism. For example, the module may be coupled to a spring-loaded plunger that retracts upon activation of the environmentally sensitive actuator so as to apply a pulling force. This pulling force may be arranged to act on a pull tab which is part of the latching mechanism against which the driving member is held, wherein a lateral movement of the pull tab releases the driving member. As described elsewhere, in some embodiments an actuation cable is also attached to the pull tab, so that the pull tab may be operated by the environmentally sensitive actuator or by remote actuation. In some embodiments, the pull tab is attached to a Bowden cable.

A benefit of a two-way actuation cable or other linkage is to allow the entire system to be reset when the valve is opened, e.g. to reconnect the gas supply. The physical valve state (e.g. ON/OFF) at the actuation unit is always reflected at the remote actuation device due to the physical linkage between them. In various embodiments, when the valve at the actuation unit is reset, there is a reset force transmitted by the actuation linkage to the remote actuation device to reset its triggering mechanism e.g. manual input element. Preferably this reset force also acts to return the remote display to gas ON.

In accordance with another aspect, the present invention provides an actuation system for a valve assembly, the actuation system comprising:
an actuation unit arranged to engage with an operating member of a valve to drive rotation of the operating member; and
a remote actuation device arranged at a distance from the actuation unit and coupled to the actuation unit by a two-way non-cable actuation linkage, the two-way non-cable actuation linkage being operable to allow the operating member to drive rotation of the operating member;
wherein the remote actuation device includes a manual input element arranged to operate the non-cable actuation linkage and a valve state indicator;
wherein rotation of the operating member is coupled to the non-cable actuation linkage so as to transmit the valve state from the actuation unit to the valve state indicator at the remote actuation device.

Thus it will be appreciated that the remote actuation device, by virtue of the physical coupling of the non-cable actuation linkage, is able to indicate the true valve state even though the remote actuation device is arranged at a distance from the actuation unit. This provides users with confidence. In such embodiments, the non-cable actuation linkage may take any suitable form, for example a mechanical linkage, flexible drive shaft, pneumatic linkage or hydraulic linkage.

Various embodiments may further comprise an environmentally sensitive actuator according to any of the examples described above.

For example, the environmentally sensitive actuator is arranged to operate the non-cable actuation linkage in response to an emergency situation; and preferably,
wherein the environmentally sensitive actuator is arranged to operate the non-cable actuation linkage when activated by one or more of: heat, fire, smoke, pressure, vibration, humidity, flood or freezing. In some examples, the environmentally sensitive actuator comprises a resettable element, e.g. a resettable bimetallic element. In some examples, the environmentally sensitive actuator comprises a sacrificial element. In some examples, the non-cable actuation linkage is the sacrificial element. In such examples, the sacrificial element may comprise a component that dissolves in a flood or melts in a fire; and/or the sacrificial element is arranged to physically break in response to environmental conditions.

In various embodiments, the valve is a gas supply valve and the environmentally sensitive actuator is arranged to operate the non-cable actuation linkage in response to one or more of: elevated heat, elevated pressure, fire, or smoke; or the valve is a water supply valve and the environmentally sensitive actuator is arranged to operate the non-cable actuation linkage in response to flood or freezing conditions; or the valve is a water control valve and the environmentally sensitive actuator is arranged to operate the non-cable actuation linkage in response to one or more of: elevated heat, elevated pressure (e.g. explosion), fire, or smoke.

In any of these examples, the environmentally sensitive actuator may be arranged between the remote actuation device and the actuation unit. For example, the environmentally sensitive actuator comprises an in-line resettable element. For example, the non-cable actuation linkage includes an in-line sacrificial element module; and preferably, the in-line sacrificial element module is a replaceable module. In some examples, the environmentally sensitive actuator is integrated with the non-cable actuation linkage.

In embodiments according to any of the aspects of the present invention, the actuation unit may comprise a torsion spring, a trigger member, and a driving member, said driving member being arranged to engage with an operating member of a valve to drive rotation of the operating member, wherein the torsion spring applies a first torque to the driving member around the axis in a first rotational direction; wherein an external second torque applied opposite to the first torque resets the valve to an open position in which the driving member is held by a latching mechanism, thereby resisting the first torque of the torsion spring, said latching mechanism being arranged to hold the driving member only when the valve is in the open position; and wherein an external force applied to the trigger member releases the driving member such that it is no longer held by the latching mechanism, the first torque thereby rotating the driving member in the first rotational direction so as to drive rotation of the operating member and mechanically bias the valve to the closed position.

In such embodiments the valve is retained in the open position until a triggering force is applied by a user. Once triggered, the ‘spring-loaded’ actuation unit biases the valve to the closed position automatically, i.e. the user does not need to apply any torque to close off the valve. The valve can then be reset by applying a restorative torque in the opposite direction to bring the valve back to the open position, where it is held by latching the driving member. The valve is only latched in the open position when the valve is fully opened (i.e. in the open position). If the restorative torque restores the valve to some intermediate position between the closed and open positions, the latching mechanism has no effect and thus the torque spring biases the valve back to the closed position when the insufficient external torque is no longer applied. By way of example only, the actuation unit may be an EasyAssist® actuation unit.

In other words, the force for closing the valve is ‘de-coupled’ from the force required to open the valve. A user may simply operate the trigger member, which acts to force the valve closed by releasing the torque of the torsion spring. This may be particularly advantageous for users with physical impairments, however it has been appreciated that this may also generally make shutting off the valve easier in installations in which physical access to the valve is restricted (e.g. in closed or unusually shaped spaces).

It will be appreciated that the term ‘open position’ means that the valve is substantially open, preferably fully open, thereby allowing flow of fluid through the valve. Similarly, the term ‘closed position’ means that the valve is substantially closed, preferably fully closed, thereby preventing flow of fluid through the valve. Thus the actuation device latches only when the valve is in a position in which the valve is effectively fully open, and does not latch at any intermediate position.

The valve itself may be a new valve that is fitted together with the actuation unit, however the actuation unit may be supplied alone and can be ‘retro-fitted’ to existing valves that are already in situ, e.g. an existing gas supply valve in a domestic application.

Generally speaking, and in preferred embodiments, the external force required to release the driving member is less than the force that would be required to manually close the valve. Release of the driving member from the latching mechanism allows a relatively large amount of stored energy (i.e. from the torsion spring) to be applied to the operating member of the valve for a potentially relatively small amount of input energy from the user (i.e. to operate the trigger member).

Embodiments in which the force required to close the valve is reduced may be particularly advantageous. However, additionally or alternatively, in some advantageous embodiments the external force applied to the trigger member is a non-rotary force. Some physical impairments may significantly affect the ability of a user to apply a twisting motion (e.g. to twist a valve handle), while the ability to apply a non-rotary force (such as a push or a pull) may not be as severely impaired.

Of course, in a set of embodiments, a non-rotary external force may advantageously be less than the rotary force (i.e. the ‘first torque’) that closes the valve. The non-rotary force may, for example, be a linear force. This non-rotary force may be instantaneous, rather than a continual pushing in of the button, i.e. it is a ‘binary’ system such that once a sufficient non-rotary force is applied to the trigger member, the valve is triggered closed.

The Applicant has appreciated a number of mechanisms for an externally applied non-rotary force to release the driving member. In some embodiments, the trigger member comprises a button, wherein the driving member is released when the button is pressed. A button may be preferred due to the ease with which a user can press it.

The button itself may comprise a trigger spring arranged to return the button to a normal position after it has been pressed. It will be appreciated that the ‘spring’ may be any resilient member applying a bias force (e.g. an elastomeric or coil spring). The trigger spring, which may be a compression spring, may also advantageously determine (at least partially) the magnitude of the external force required to trigger the actuation unit into closing the valve, as the force of the trigger spring must be overcome when pressing the button. In some embodiments, a selection of spacers—which may include washers or other suitable components having a particular height or selection of heights—may be added in-line with the trigger spring to ‘fine-tune’ the amount of force needed to actuate the button. Additionally or alternatively, a nut may be loosened or tightened to adjust the height so as to influence the magnitude of the external force required to trigger the actuation unit into closing the valve. Additionally or alternatively, the trigger spring may be selected from a plurality of trigger springs each having a different respective spring constant and/or spring geometry. Thus the actuation device may be supplied in a kit together with a choice of trigger springs to allow for fine-tuning of the external force required to trigger the actuation unit into closing the valve.

The button may be positioned conveniently with respect to the actuation unit so as to allow easy access for the user. In some such embodiments, the trigger member comprises a top button positioned such that the top button is actuated by applying a longitudinal force to the top button in a direction parallel to the axis of the valve. In a set of such embodiments, the longitudinal force is to be applied along the axis of the valve, i.e. a coaxial force applied to the top button releases the driving member. Thus, in such embodiments, the axial movement of the button releases the latching mechanism. For example, the driving member may be displaced axially relative to the housing of the actuation unit so as to release the driving member and allow the first torque (from the torsion spring) to drive the valve closed.

In some potentially overlapping embodiments, the trigger member comprises a side button positioned such that the side button is actuated by applying a lateral force to the side button perpendicular to the axis of the valve. In some embodiments, the trigger member comprising a pair of side buttons arranged on opposite sides of the actuation unit. This may, for example, provide a mechanism in which the user ‘squeezes’ the sides of the unit in order to close the valve. The side button (or each side button) may be a lever. In some such examples, the driving member may be displaced laterally relative to the housing of the actuation unit so as to release the driving member and allow the first torque (from the torsion spring) to drive the valve closed.

Where a button is provided, the button may be located within a button housing. In some embodiments, the latching mechanism may comprise the button housing. Thus, in such embodiments, the driving member may be retained by the button housing until the button is actuated, which may, for example, move the driving member relative to the button housing so as to release the driving member from the latching mechanism.

In addition to buttons, there are other triggering mechanisms that may be used. For example, in some potentially overlapping embodiments, the trigger member comprises a pull tab. The pull tab may, in some embodiments, also provide a latch member against which the driving member is held when held by the latching mechanism, wherein a lateral movement of the pull tab releases the driving member.

Such a pull tab may be pulled from the latched position manually, for example by gripping the tab and pulling it. However, in some embodiments an actuation cord is attached to the pull tab, wherein pulling of the actuation cord applies the external force to the pull tab. The actuation cord may be coupled to a remote actuation device according to any of the embodiments described above.

In some potentially overlapping embodiments, the actuation cable is not arranged to operate the trigger member or pull tab, but instead directly releases the driving member such that it is no longer held by the latching mechanism. In addition to (or instead of) the latching mechanism, the actuation cable may operate an interference member arranged to interfere with the driving member, e.g. such that a pull force from the actuation cable moves the interference member out of the way of the drive member.

In some embodiments, the driving member is substantially annular. In some embodiments, the driving member is centred on the axis of the valve. By having the driving member centred with respect to the axis of the valve, the forces exerted by the actuation unit are ‘balanced’ such that no ‘twist’ is applied across the valve and/or pipe in which the valve is fitted that may cause damage, i.e. the forces exerted are symmetric. In some potentially overlapping embodiments the driving member is seated inside the torsion spring. For example, where a clock spring is used, the driving member may sit inside the innermost coils of the clock spring.

Those skilled in the art will appreciate that a driving member as described herein may be referred to as “an arbor”.

The driving member may, at least in some embodiments, comprise a substantially cylindrical component with a ridged portion arranged to hold the driving member in position when latched.

There are a number of ways of latching the driving member such that it holds the valve in the open position. However, in some embodiments, the actuation unit comprises a housing, wherein the driving member (e.g. its ridged portion) is held in abutment against at least a part of said housing when latched. The housing may have a multi-part construction. In some embodiments, the housing may comprise a body portion and/or a lid portion. The part of the housing against which the driving member is held when latched may, at least in some embodiments, be a lid of the housing. Using the housing to hold the driving member in place may be beneficial where a particularly compact arrangement is required.

In embodiments where a lid portion is provided, the lid portion may partially or wholly enclose a cavity defined by the body portion (i.e. it may be a ‘complete’ lid in which the cavity is wholly enclosed, or a ‘partial’ lid in which there is at least one gap between the cavity and the outside world). For example, in embodiments in which a tab is provided that may be pulled in order to release the driving member as described in further detail below), the lid may partially enclose the cavity defined by the body portion, where the tab completely encloses the cavity when latched.

In some such embodiments, the latching mechanism comprises a tab that, when latched, is held in abutment against a stop face. When the external force is applied to the trigger member (e.g. the tab is pulled away from the stop face), the driving member is released and the valve is driven to the closed position. As will be understood by those skilled in the art, a latching mechanism is typically constructed from a ‘latch’ (a part that moves and can be held) and a ‘keeper’ (a part that is static and holds the latch). In some such embodiments, the tab and stop face may be the latch and keeper respectively, or vice versa.

In a set of embodiments, the stop face is provided on the housing, e.g. on a part of the lid portion.

In a set of potentially overlapping embodiments, the tab is provided on the driving member. However, in some embodiments, the tab is provided on the trigger member, wherein the trigger member mechanically engages the driving member such that both the trigger member and driving member rotate about the axis of the valve together. For example, the tab may be provided on the button housing in one set of embodiments as described herein. Rather than having the trigger member mechanically engage the driving member, arrangements are envisaged in which the trigger member and driving member are of integral construction.

In some embodiments, the latching mechanism is arranged to direct a portion of the external force applied to the trigger member as a rotational force applied to the driving member. For example, where the trigger member comprises a top button, a portion of the longitudinal force applied to the top button in the direction parallel to the axis of the valve may be translated to a rotational force applied to the driving member.

The Applicant has appreciated different mechanisms for providing this translation of a non-rotational force to a rotational force. In some embodiments in which the driving member comprises a tab as outlined above, the tab may comprise a chamfered side surface at an oblique angle to the axis about which the valve rotates, wherein the chamfered side surface of the tab abuts the stop face when the driving member is held by the latching mechanism. In some potentially overlapping embodiments, the stop face of the housing comprises a chamfered side surface at an oblique angle to the axis about which the valve rotates, wherein the chamfered side surface of the stop face abuts the tab when the driving member is held by the latching mechanism. Preferably, the tab and stop face each comprise a chamfered side surface, wherein the chamfered side surface of the tab corresponds to the chamfered side surface of the stop face, i.e. their sloped side surfaces (that touch when latched) match one another. In a potentially overlapping set of embodiments, the tab may comprise a chamfered front surface.

Those skilled in the art will appreciate that the term ‘chamfered’ as used herein means that the tab and/or stop face may have a wedge-like construction. The Applicant has appreciated that such an arrangement is particularly advantageous because it may make triggering the release of the driving member easier for a user. This effect is achieved because the slope of the tab and/or stop face (and preferably both) translates a component of the lateral force from the torsion spring to a downward force such that, once the trigger member starts to move, the force of the torsion spring ‘assists’ the trigger members motion. The tab and/or stop face may each have a pair of chamfered side surfaces, such that the movement of one past the other is made easier regardless of whether the rotation about the axis is clockwise or anti-clockwise.

The oblique angle of the slope (the angle between the normal to the surface and the axis around which the valve rotates) will depend on force requirements and an appropriate selection can be made, however in some embodiments, the angle of the slope may be equal to or less than approximately 60°, optionally equal to or less than approximately 40°, and preferably equal to or less than approximately 20°. In a set of embodiments, the angle of the slope is between approximately 1° and 60°, for example between approximately 41° and 60°, preferably between approximately 21 and 40°, and most preferably between approximately 1° and 20°.

In a potentially overlapping set of embodiments the tab and/or stop face may have a curve-like construction in which the tab and/or stop face may each have a pair of curved side surfaces. Thus the tab may, in some embodiments, comprise a curved side surface having a varying angle to the axis about which the valve rotates across said curved surface, wherein the curved side surface of the tab abuts the stop face when the driving member is held by the latching mechanism. In some potentially overlapping embodiments, the stop face of the housing comprises a curved side surface having a varying angle to the axis about which the valve rotates across said curved surface, wherein the curved side surface of the stop face abuts the tab when the driving member is held by the latching mechanism. Preferably, the tab and stop face each comprise a curved side surface, wherein the chamfered side surface of the tab corresponds to the curved side surface of the stop face, i.e. their sloped side surfaces (that touch when latched) match one another. In a potentially overlapping set of embodiments, the tab may comprise a curved front surface.

Those skilled in the art will appreciate that this may provide a screw-thread like construction, where the ‘thread pitch’ may be relatively coarse. Such an arrangement may advantageously ease turning of the driving member.

The valve may be any of a number of valves which rotate between an open position and a closed position. However, in some embodiments, the valve is a quarter-turn valve. Those skilled in the art will appreciate that a ‘quarter-turn’ valve is a valve having substantially 90° between its open and closed positions. In some such embodiments, the valve is a ball valve. However, it will be appreciated that the principles of the present invention could also be applied to, for example, disc valves, vane valves, plug valves, etc.

In some embodiments, the valve comprises a gas supply valve, preferably a domestic gas supply valve. The gas supply valve may be positioned in-line on a domestic gas supply pipe. The gas supply valve may, in some embodiments, be a ‘standard’ gas supply valve, i.e. the valve may be manufactured in accordance with a relevant standard, as determined by an appropriate standards board. Alternatively, the valve may comprise a water supply valve or any other suitable valve for controlling fluid flow (i.e. of a liquid or gas supply).

Those skilled in the art will appreciate that a torsion spring is a type of spring arranged to store mechanical energy by twisting it. When a torsion spring is twisted, it exerts a torque in the rotational direction opposite to the rotational direction of twisting. The resulting torque is generally proportional to the angle through which the spring is twisted. One type of torsion spring that may be used is a helical torsion spring, where a wire or rod is bent into a coil, where a twisting motion applied to its ends (i.e. an applied bending moment) causes the coil to be twisted tighter. However, in some embodiments, the torsion spring comprises a clock spring, sometimes referred to as a ‘spiral wound torsion spring’ or a ‘power spring’. Unlike a helical spring, a clock spring is wound in a concentric spiral (i.e. it has ‘in-plane’ windings), such that the spring has a relatively ‘flat’ profile. This may be particularly advantageous in constructing a compact actuation unit suitable for use in physically restricted or ‘cramped’ conditions.

The actuation unit may, in some embodiments, comprise an environmentally sensitive actuator (e.g. a sacrificial element) arranged to release the driving member such that it is no longer held by the latching mechanism. This may, for example, comprise a component that dissolves in a flood or melts in a fire, allowing automatic triggering of the valve to the closed position without user input. Additionally or alternatively, a component may be arranged to physically break when overpowered with a particular input force, e.g. if the valve is forced closed manually.

In some arrangements, the driving member is positioned on a heat sensitive actuator, such as a fire protection member, said fire protection member having a melting point lower than a melting point of the driving member, wherein the fire protection member is arranged such that, when the driving member is latched, the fire protection member releases the driving member upon the fire protection member melting. The fire protection member may, for example, be a washer such as a plastic washer. Alternatively, where the trigger member comprises a pull tab, a portion of the pull tab may be arranged to melt when exposed to a sufficiently high temperature, thereby releasing the driving member. In such embodiments, the heat sensitive actuator may comprise the pull tab or a portion thereof. In such embodiments, the heat sensitive actuator may comprise any part of the latching mechanism, or an interference member for the driving member, as mentioned above.

In normal operation, the latching mechanism may be held in abutment against the heat sensitive actuator, wherein activation of the heat sensitive actuator causes the latching mechanism to be released. Such an arrangement may advantageously bias the valve to the closed position in response to exposure to a fire.

In a set of such embodiments, the heat sensitive actuator comprises a glass bulb and the latching mechanism may comprise a bulb retainer that, in normal operation, is held in abutment between the glass bulb and the driving member. In other words, the bulb retainer may resist the spring force of the driving member so long as the glass bulb remains intact.

Once assembled, one side of the bulb is held in contact with the bulb retainer. The opposite side of the bulb may be held in place by a bulb holding portion, which may for example be a suitable slot (e.g. a milled slot) located on the lid of the housing. The bulb retainer may, in some embodiments, comprise a pivot arm arranged to pivot around a pivot axis when the glass bulb breaks. This pivot arm may therefore be held against the spring force of the driving member, where the driving member can push the pivot arm out of the way upon the glass bulb breaking.

The pivot axis may extend parallel to the axis of the valve, i.e. such that the plane in which the pivot arm rotates is parallel to the plane in which the valve rotates.

While operation of the trigger member could be the only way by which the valve can be closed, in a set of embodiments, the valve assembly is arranged that an external third torque in the first rotational direction closes the valve. There may, in some such embodiments, be a threshold amount of force required to ‘overcome’ the resistance of the driving member when latched before the valve can be forced closed. This may be advantageous where a person (e.g. a firefighter) may need to manually close the valve. As outlined above, the actuation unit may comprise a sacrificial element that breaks when a user applies an external torque in the first rotational direction greater than a threshold to the valve assembly, e.g. to overpower the force of the torsion spring and close the valve manually.

It will be appreciated that the device described herein works regardless of whether closing the valve requires a clockwise rotation or an anti-clockwise rotation, i.e. the first rotational direction may be clockwise and the second rotational direction may be anti-clockwise, or vice versa. In some embodiments, the torsion spring is invertible, such that the respective directions of the first and second rotational directions may be swapped. For example, where a clock spring is used, the clock spring may, in such embodiments, be flipped over. In some embodiments, the torsion spring is sealed within a housing, and so the determination of the directions is made during manufacturing, however other arrangements are envisaged in which the torsion spring may be placed in the desired orientation during installation so as to fit a particular end-use.

In some embodiments, the operating member of the valve comprises a stem that extends along the axis of the valve. Such a stem may, for example, be threaded. Additionally or alternatively, the operating member of the valve may comprise a handle, e.g. extending laterally from the stem. The driving member may be physically attached to the operating member, for example attached to the stem or the handle of the valve.

In some embodiments, the valve assembly comprises a visual indicator that indicates when the valve is in the open position and when the valve is in the closed position. This can be helpful to allow a user to easily see at a glance the current operating state of the valve.

For example, in embodiments where the operating member of the valve comprises a handle, the handle may aid identification of the operating state of the valve. In some embodiments, a first visual marker indicates the open position and a second visual marker indicates the closed position, wherein in the open position, the handle covers the second visual marker, and wherein in the closed position, the handle covers the first visual marker. In some such embodiments, the handle is elongate, wherein a portion of the elongate handle obscures the first and second visual markers in the appropriate positions. It will be appreciated that visual markers include any suitable verbal or symbolic visual markers including: the words ‘ON’ and ‘OFF’; the words ‘OPEN’ and ‘CLOSED’; the numbers ‘1’ and ‘0’; symbols such as a tick and a cross; illustrative symbols showing a valve being open or closed; illustrative symbols showing fluid flow and no fluid flow; colour coding; arrows; etc.

In some embodiments, the actuation unit comprises an engagement portion arranged to engage with a pipe. This engagement portion acts as a ‘strap’ such that, where the valve is connected in-line with a pipe, the actuation unit can be fixed around the valve and affixed to the pipe. The engagement portion could comprise a removable piece that is positioned on the opposite side of the pipe to the rest of the actuation unit, where these are then fixed together by a suitable fastening means, e.g. screws or a nut and bolt arrangement. The removable piece and the actuation unit (e.g. a housing of the actuation unit) may be supplied with through-holes that align when the removable piece is in place, where a suitable fastener may hold this in place.

The removable piece may be ‘U-shaped’ (i.e. of a horseshoe-like construction) that forms a collar around the pipe when affixed.

In a set of such embodiments, the engagement portion may comprise a hinged portion. Providing a hinged mechanism may advantageously allow the actuation unit to be easily clamped around the valve and affixed to the pipe and for easy removal of the actuation unit from the pipe. The actuation unit may have a ‘double hinge’, where the hinge can open on two opposite sides of the actuation unit so as to allow placement around pipes in different spaces. Arrangements are envisaged in which a removable piece with through holes may be fixed to the housing of the actuator through one of the sets of through-holes thereby forming the hinge, however in other arrangements a dedicated hinge may be provided.

The torsion spring may come ‘pre-loaded’ in the valve assembly such that the valve assembly is assembled onto a valve when the valve is in the closed position. Once assembled, the valve is then moved to the open position (e.g. with a manual 90° turn to the open position).

In some embodiments, a safety cover may be provided that contains the rest of the valve assembly, wherein the trigger member may be accessed through the safety cover (e.g. a button may protrude through the safety cover). The safety cover may, in a set of embodiments, comprise a transparent window through which the handle of the valve may be seen, thereby providing a visual indication of whether or not the valve is closed. The safety cover may be locked closed around the valve assembly, preventing the valve from being re-opened after it is triggered without the key to the safety cover. Such a key may, for example, only be held by authorised persons such as gas engineers or firefighters.

### BRIEF DESCRIPTION OF THE DRAWINGS

Certain embodiments of the present invention will now be described with reference to the accompanying drawings, in which:

FIGS. 1A and 1B show an overview of an actuation system;

FIGS. 2A and 2B are cross-sectional drawings of a quarter-turn valve;

FIGS. 3A-3E are views of a remote actuation unit;

FIGS. 4A-4C are views of another remote actuation unit;

FIGS. 5A-5E are internal views showing operation of the remote actuation unit of FIG. 4A;

FIGS. 6A-6B are schematics of cable operation at an actuation unit;

FIGS. 7A-7B are schematic drawings that illustrate operation of a pre-tensioned actuation cable;

FIG. 8 is an exploded view of an exemplary actuation unit;

FIGS. 9A-E are schematic drawings illustrating operation of the actuation unit of FIG. 8;

FIG. 9F shows the actuation unit including a pull tab operable by an actuation cable;

FIG. 10 schematically shows operation of a push/pull Bowden cable;

FIGS. 11-13 show schematically how a Bowden cable can be operable at the actuation unit;

FIGS. 14A-14B show examples of a two-way mechanical linkage;

FIGS. 15A-15B show an example of a hydraulic linkage;

FIG. 16 shows an example of a pneumatic linkage;

FIGS. 17A-17B show another example of a pneumatic linkage; and

FIGS. 18A-18B shows an example of a one-way mechanical linkage;

FIGS. 19A-19C and 20A-20F show views of another example remote actuation device;

FIGS. 21A-21B show views of another example remote actuation device;

FIG. 22 is a schematic drawing of spring movement for activation and reset of an example remote actuation device;

FIGS. 23A-23B show the remote actuation device employing an example state sensing arrangement;

FIGS. 24A-24C show the remote actuation device employing another example state sensing arrangement;

FIGS. 25A-25C show the actuation unit employing an example state sensing arrangement;

FIG. 26 shows a schematic diagram for wireless monitoring of the actuation system.

### DETAILED DESCRIPTION

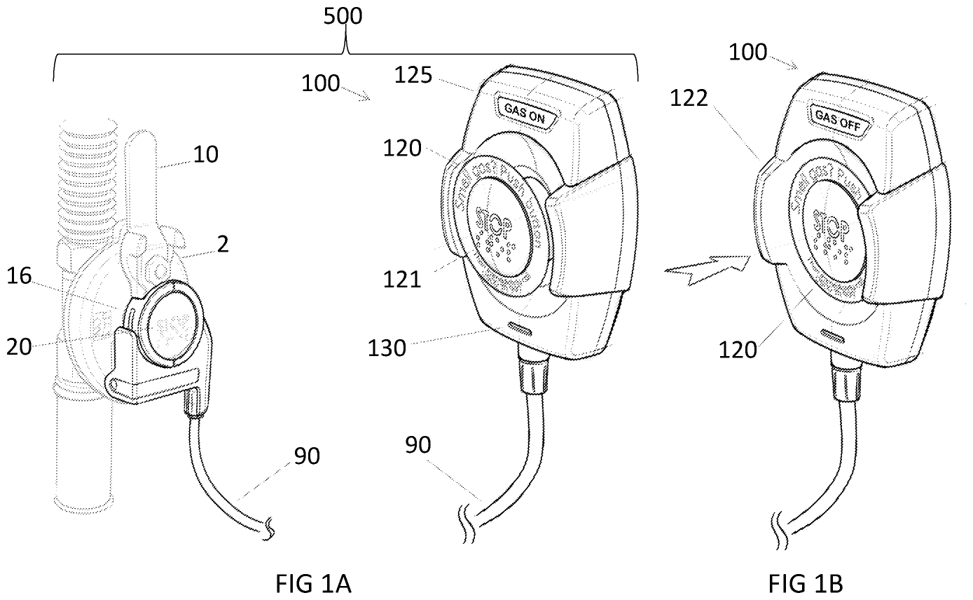

FIG. 1A shows an actuation system 500 comprising an actuation unit 16 arranged to engage with an operating handle 10 of a valve 2 e.g. a quarter-turn valve in a gas pipe. The actuation unit 16 includes a trigger button 20. As seen on the right in FIG. 1A, a remote actuation 100 device is positioned at a distance from the actuation unit 16 and coupled to the actuation unit 16 by a flexible actuation cable 90. The cable length is nominally 2 m, but can be extended as required. The cable 90 can be external or routed behind walls. The remote unit 100 can mount to a wall in an easily accessible location. In this example, the remote actuation device 100 includes an environmentally sensitive actuator, such as a heat activated fuse, arranged to operate the actuation cable 90. The remote unit 100 comprises a high visibility stop button 120 with braille description 121 on the button 120, and a clearly visible gas supply status 125. FIG. 1B shows the remote unit 100 with the button 120 depressed, showing side walls 122 which prevent accidental actuation.

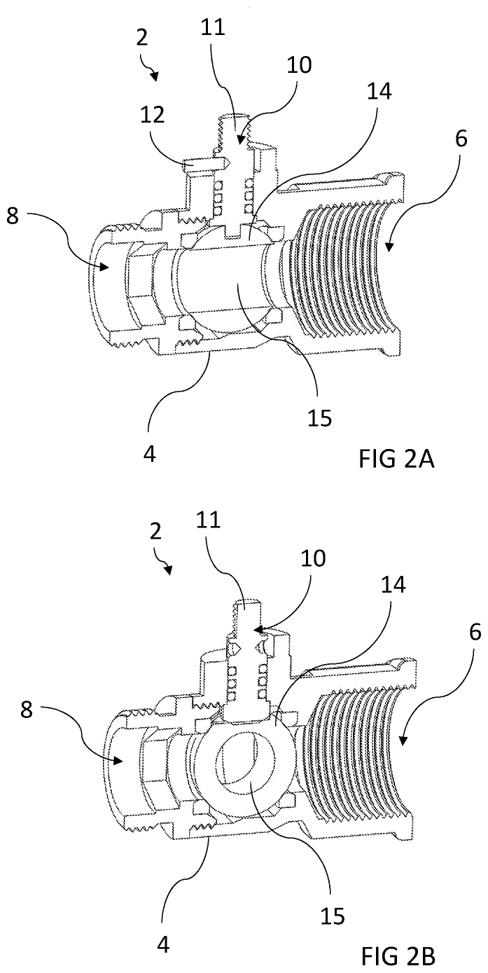

FIGS. 2A and 2B are cross-sectional drawings of a quarter-turn valve 2. In particular, the valve 2 shown is a quarter-turn ball valve, as outlined in further detail below. The valve 2 comprises a valve housing 4, with two fluid apertures 6, 8 which allow ingress of a fluid, i.e. a liquid or a gas, into the valve 2. An operating member 10 is arranged to rotate a quarter turn between an ‘on’ position (as shown in FIGS. 2A) in which fluid may flow freely through the valve 2, and an ‘off’ position (as shown in FIGS. 2B) in which the fluid is prevented from flowing through the valve 2. Typically, a handle (not shown) is attached to a stem 11, which may be threaded, such that rotation of the handle rotates the stem 11 about an axis, thereby rotating a ball 14 within the valve housing 4 about the axis of the stem 11.

The ball 14 has a hollow cylinder 15 running through it, such that in the on position, the flow axis of the hollow cylinder 15 is aligned with the axis of the valve 2 such that fluid may pass through the valve 2. In the off position, however, the flow axis of the hollow cylinder 15 is perpendicular to the flow axis of the valve 2, such that there is no fluid flow path, thereby preventing flow of the fluid.

It will be appreciated that intermediate positions between the on and off positions may reduce but not completely inhibit fluid flow, however generally an emergency valve such as an emergency domestic gas shut off valve is either ‘on’ or ‘off’, with intermediate positions being undesirable for safety reasons well understood by those skilled in the art.

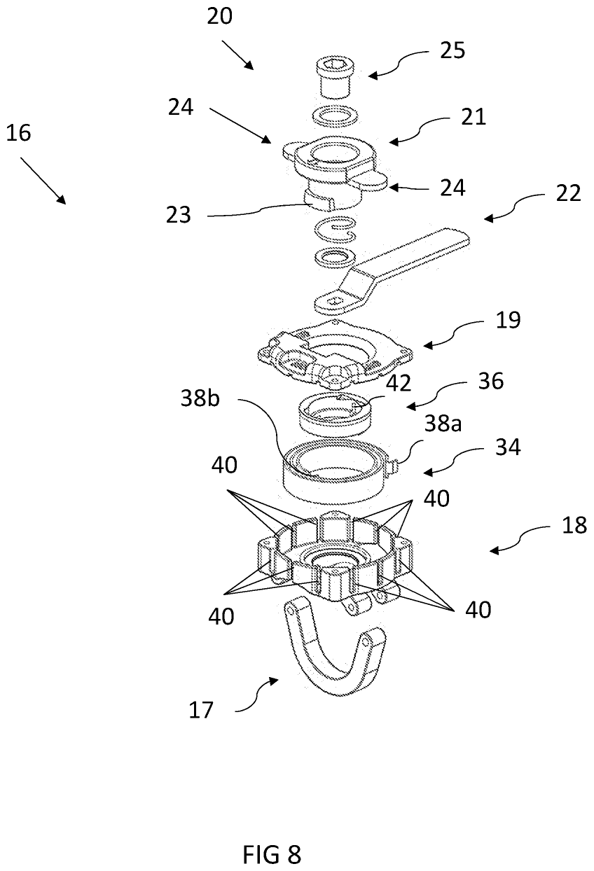

As seen from the exploded view of FIG. 8, a suitable actuation unit 16 includes a top button 20 including the handle 22 used to operate the valve 2. The actuation unit 16 is constructed from a housing 18 fitted a lid 19, a top button 20 (i.e. a trigger member) including a button inner 25 which is positioned within, and is movable vertically relative to, a button housing 21. The button housing 21 is also moveable vertically relative to the housing 18, as explained in further detail below.

A hinged portion 17 is positioned at the bottom of the actuation unit 16, and ‘hinges’ away from the housing 18. This hinged portion 17 acts as a ‘strap’ such that, where the valve 2 is connected in-line with a pipe (not shown), the hinged portion 17 allows the actuation unit 16 to be clamped around the valve 2 and affixed to the pipe. This hinged portion 17 may be ‘double hinged’, such that the strap may open in either direction, as different installations may require that the strap open one direction or the other in order to fit it around the pipe. It will of course be appreciated that other arrangements are possible, e.g. the hinged portion 17 could instead be a wholly separate piece that is screwed or bolted to the housing 18 once the actuation unit 16 is in place.

The handle 22 may be supplied as part of the actuation unit 16 or may be an existing handle associated with the valve 2 which is removed when the actuation unit 16 is fitted, and then re-attached once the actuation unit 16 is in place. A tab-shaped protrusion 23 extends from an outer surface of the button housing 21 and is arranged to latch against the housing 18 of the actuation unit 16, as outlined in further detail below.

The button housing 21 engages with the operating member 10 of the valve 2, specifically with the stem 11, via an arbor 36 as outlined in further detail below. It will be appreciated that in other embodiments, the button housing 21 may additionally or alternatively engage with the handle 22 (again, via the arbor 36 outlined below) which, in turn, engages the stem 11.

In this example, two side tabs 24 extend from the button housing 21, though these could form part of the handle 22 in some embodiments, e.g. the handle 22 and side tabs 24 could be of integral construction. An ‘on’ indicator 26 and an ‘off’ indicator 28 are located on the upper face of the lid 19. Depending on whether the valve 2 is in the open or closed position, only one of these indicators 26, 28 is visible at a time, the other indicator 26, 28 being covered by the side tabs 24. This allows a user to easily see at a glance the current operating state of the valve 2, i.e. whether it is open or closed. In the illustrated embodiment, the ‘on’ indicator 26 and an ‘off’ indicator 28 are the words ‘ON’ and ‘OFF’ respectively, however it will be appreciated that these indicators may be any other form of verbal or symbolic indicator, for example colours, symbols, pictograms, words, letters, ticks/crosses, etc. as appropriate.

As will be explained in further detail below, pushing the button 20 in the downward direction 30 (i.e. vertically relative to the button housing 21) releases a driving member from a latch, causing the driving member to force the valve 2 from the open position (see FIG. 2A) to the closed position (see FIG. 2B), by rotating the operating member 10 of the valve 2 around its axis, i.e. in a rotational direction 32.

Within the housing 18 is located a torsion spring 34 and an arbor 36 (i.e. a driving member). The torsion spring 34 has a tab 38a, 38b at each end of the spring 34. The outermost tab 38a is, when assembled, held in place in a slot 40 of the housing 18. The housing 18 may be provided with a number of these slots 40, such that the ‘built in’ torsion of the torsion spring 34 (i.e. a ‘torsional pre-load force’) may be adjusted by placing the tab 38a in a particular slot 40. The innermost tab 38b is, when assembled, held in place in a slot 42 of the arbor 36. Thus, rotating the arbor 36 relative to the housing 18 varies the torsion of the torsion spring 34, storing energy within the spring 34.

When the valve 2 is in the closed position, a user must apply a sufficient external torque in order to reset the valve 2 to the open position. In order to achieve this, the user applies a force to the handle 22, which is coupled to the arbor 36, which in turn is coupled to the operating member 10 of the valve 2. As the arbor 36 is rotated relative to the housing 18 in response to an external torque applied to the handle 22, the operating member 10 of the valve 2 rotates from the closed position to the open position. Once in the open position, the button inner 25 is free to ‘pop up’. Once the open position is reached, the arbor 36 is held in place by the housing 18. Thus the arbor 36 is ‘latched’ by the housing 18 until the button 20 is pressed.

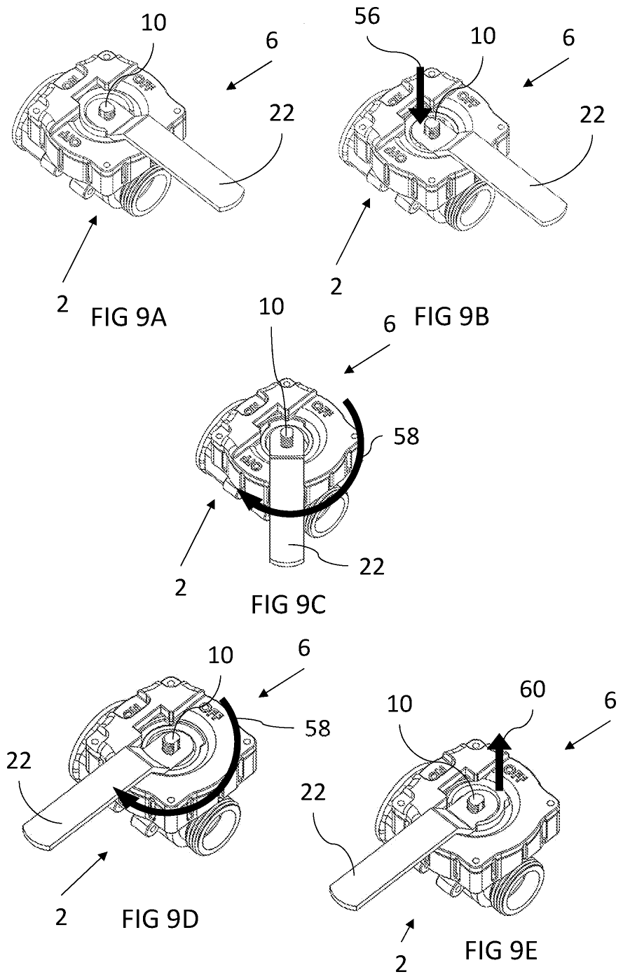

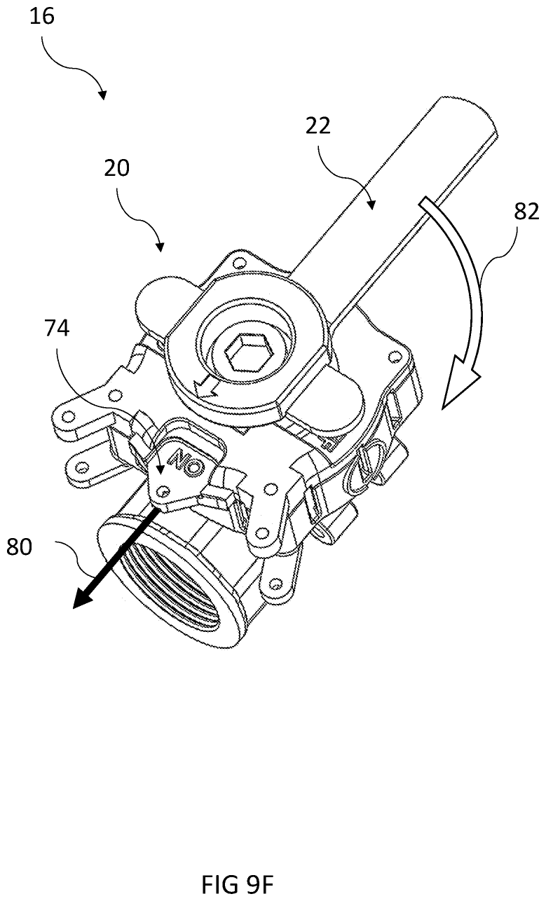

An overview of operation when the button 20 is pressed can be seen in FIGS. 9A-E.

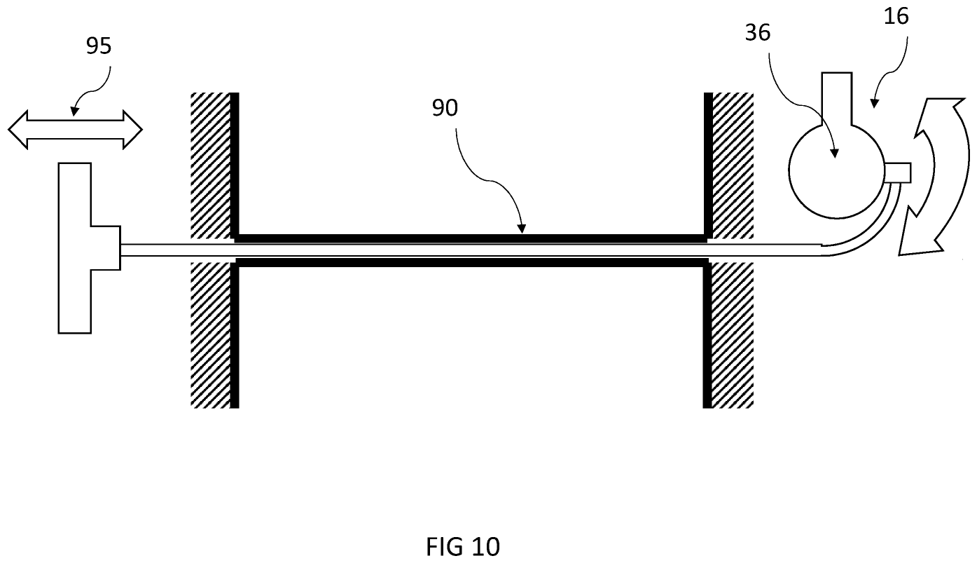

FIG. 9A shows the actuation unit 16 when the valve 2 is in the open position, without the button assembly visible for ease of understanding. In this position, the valve 2 is held in the open position, because the arbor 36 is latched as outlined above. As can be seen in FIG. 10A, in the open position, the rotational force 58 of the torsion spring 34 cannot close the valve because of the latching mechanism, i.e. the tab 44 on the button housing 21 is held in abutment against the stop face 46. The tab 44 is biased upwards by the trigger spring 54.

The user then presses down the button 20 by applying an ‘axial’ force 56, i.e. along the axis of the operating member 10 of the valve 2, as shown in FIG. 9B, compressing the trigger spring 54. As can be seen in FIG. 10B, this moves the tab 44 downwards relative to the stop face 46. Due to the chamfered side surfaces 48, 50 of the tab 44 and stop face 46, a component 59 of the rotational force 58 provided by the torsion spring assists with the downward motion of the tab 44.

This allows the tab 44 on the button housing 21 to pass under the stop face 46 of the housing 18, releasing the arbor 36 from the latching mechanism and permitting the torsion spring 34 to impart a rotational force 58 on the arbor 36, as shown in FIG. 9C.

Once the tab 44 has moved sufficiently downwards relative to the stop face 46 as shown in FIG. 9C, the tab 44 passes under the stop face 46 as shown in FIG. 10C. The rotational force 58 is then free to bias the valve 2 to the closed position, as shown in FIG. 9D.

Once in the closed position, the trigger spring 54 imparts an upward axial force 60, which pops the button 20 up as shown in FIG. 9E, and the tab 44 moves upward relative to the stop face 46, on the other side of the stop face 46 having gone through a rotation of 90°. The button 20 moving upwards may make an audible click which may indicate to the user that the valve is closed.

FIG. 9F is a schematic drawing that shows an actuation unit 16 with a pull-tab trigger mechanism. This actuation unit 16 can be coupled to the Bowden cable and remote actuation device according to the overview seen in FIG. 1. A bypass plate 74 provides a latching mechanism by which the arbor is held in place. The actuation unit 16 has a top button 20 trigger and handle 22 which operate in the same way described with reference to the actuation unit 16 FIGS. 8 and 9A-9E.

When a user presses the remote button at the remote actuation device (FIG. 1), this force is transmitted by the inner core of the Bowden cable, attached to the button. The other end of the inner core of the Bowden cable is connected to the bypass plate 74, which acts as a pull tab. The cable transmits a pulling force that applies a lateral force 80 to the bypass plate 74 (FIG. 9F). The bypass plate 74 therefore moves backwards, away from the arbor, allowing button tab to pass and thus the arbor to rotate in the rotational direction 82, therefore driving the operating member of the valve toward the closed position. During this force transmission and motion, the remote indicator at the remote actuation device changes to indicate that the valve is not fully closed (as seen in FIG. 1).

Returning to FIG. 1, it will be understood that the remote actuation device is coupled to the actuation unit by the actuation cable (e.g. a Bowden cable) in any suitable way that enables operation of the actuation cable to engage the actuation unit to drive rotation of the valve, e.g. by releasing the arbor 36 and permitting the torsion spring 34 to impart a rotational force 58 thereon.

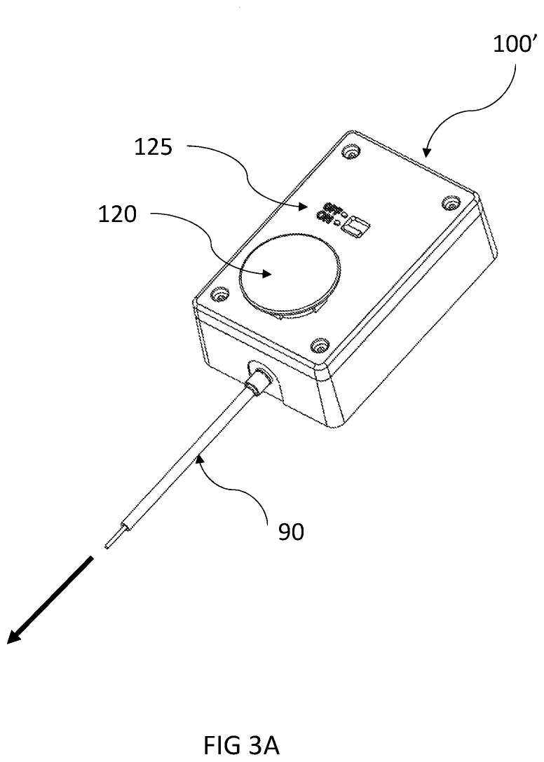

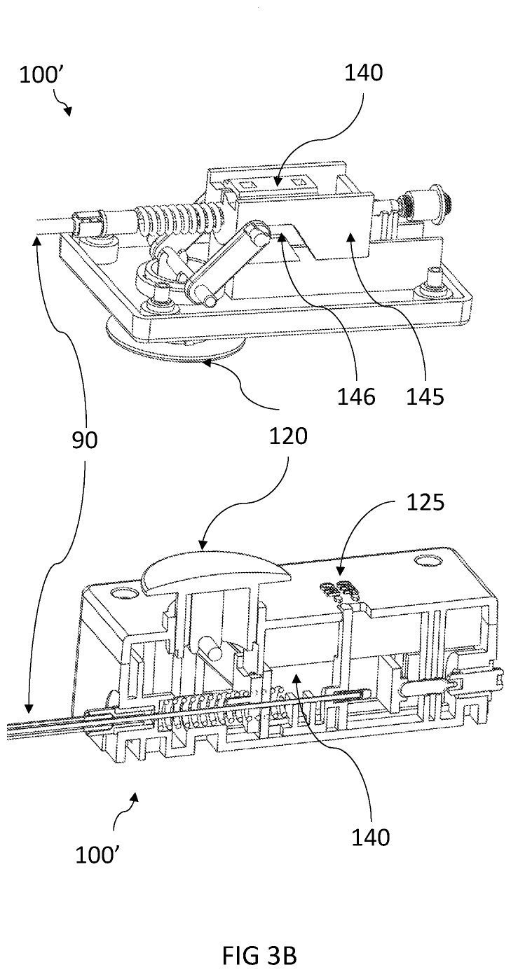

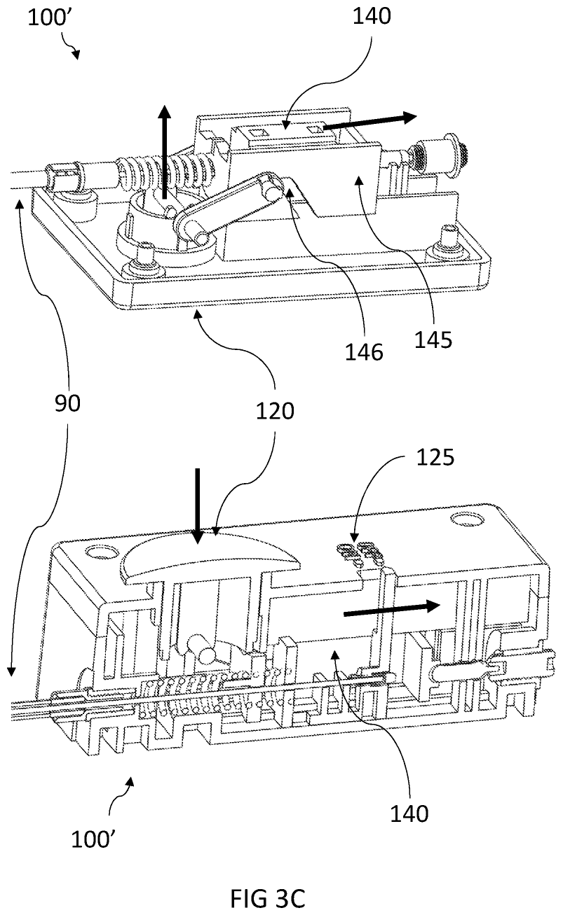

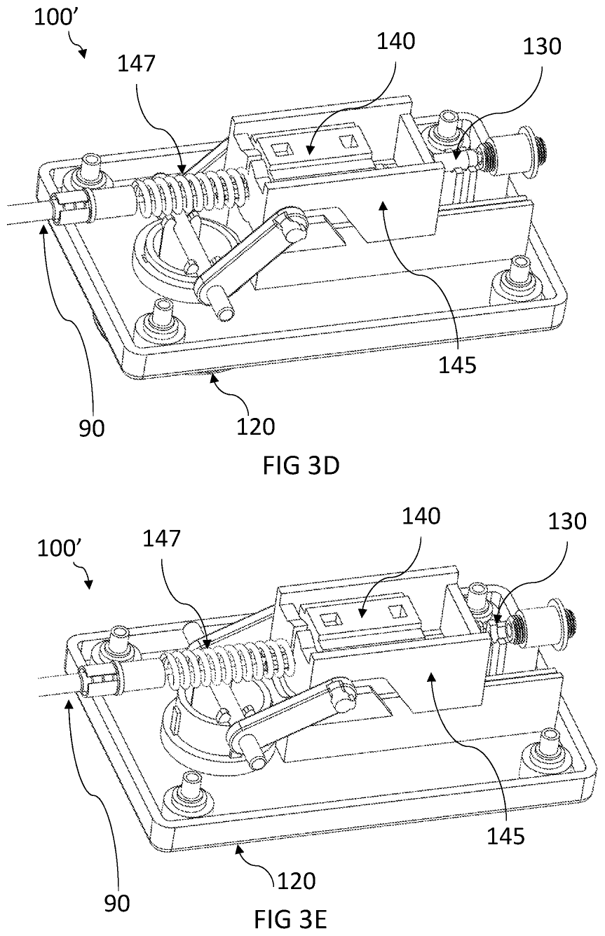

FIG. 3A shows a remote actuation device 100′ with a Bowden cable 90, stop button 120 and indicator 125. FIG. 3B shows the remote actuation device 100 when the manual input element 120 (button) is up. Button press moves the inner carriage 140 forward to pull the Bowden cable 90 and activate the triggering mechanism of the actuation unit, as seen in FIG. 3C. In other words, the inner carriage 140 is a remote trigger member coupled to one end of the Bowden cable 90. Slot 146 in the outer carriage 145 allows the inner carriage 140 to move forward independently when the button 120 is pressed. In FIGS. 3A and 3B a pointer indicates valve on 125. In FIG. 3C the pointer indicates valve off 125.

FIGS. 3D and 3E show activation of an environmentally sensitive actuator 130 in the form of a heat activated bulb. When the bulb 130 fractures, this allows the outer carriage 145 to move forward under the action of the outer carriage spring 147 which in turn moves the inner carriage 140 (i.e. remote trigger member), pulling the Bowden cable 90 and triggering the actuation unit to close the valve. This acts to pull the button 120 down as well.

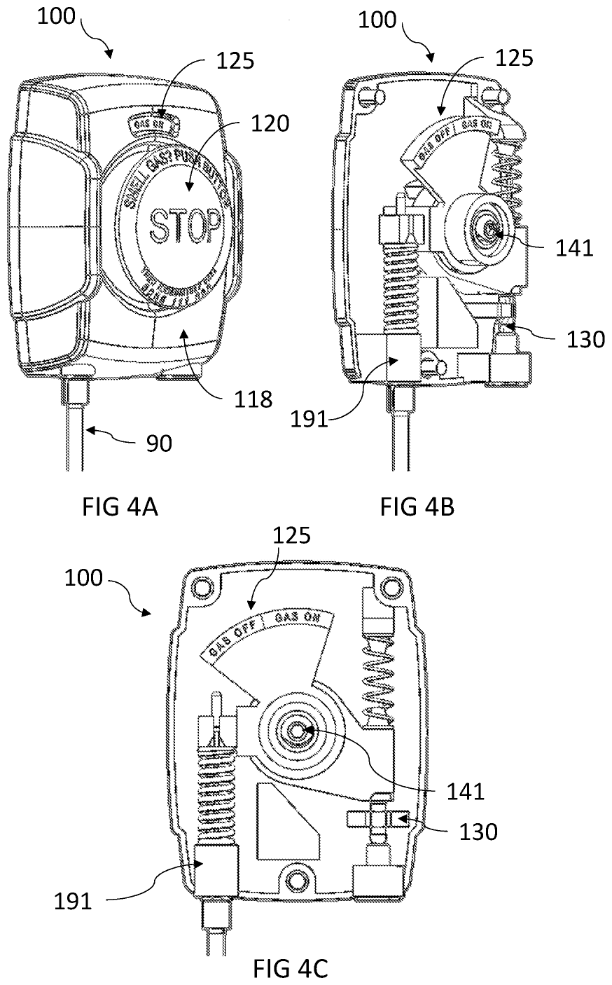

FIGS. 4A-4C show another example of a remote actuation device 100. The triggering components pivot on a central axis 141, instead of sliding laterally (as seen for the remote trigger member in FIGS. 3A-3E). This minimises the amount of surface friction, reducing the chance of component wear. These adjustments make the mechanism more suitable for repeat triggering. As the components rotate when triggered (rather than translate) there is a possibility to make the casing a compact cylinder concentric with the axis 141 of the mechanism.

The Bowden cable attachment 191 is placed on one (left) side of the mechanism, the heat sensitive bulb 130 is placed on the opposite (right) side of the mechanism. This helps create a compact product and symmetry in the outer casing 118. The gas On/Off indicator 125 is attached directly to the rotating part of the mechanism. When the parts rotate, they pull the Bowden cable 90 and simultaneously rotate the gas indicator 125 to ‘GAS ON’ to notify the user.

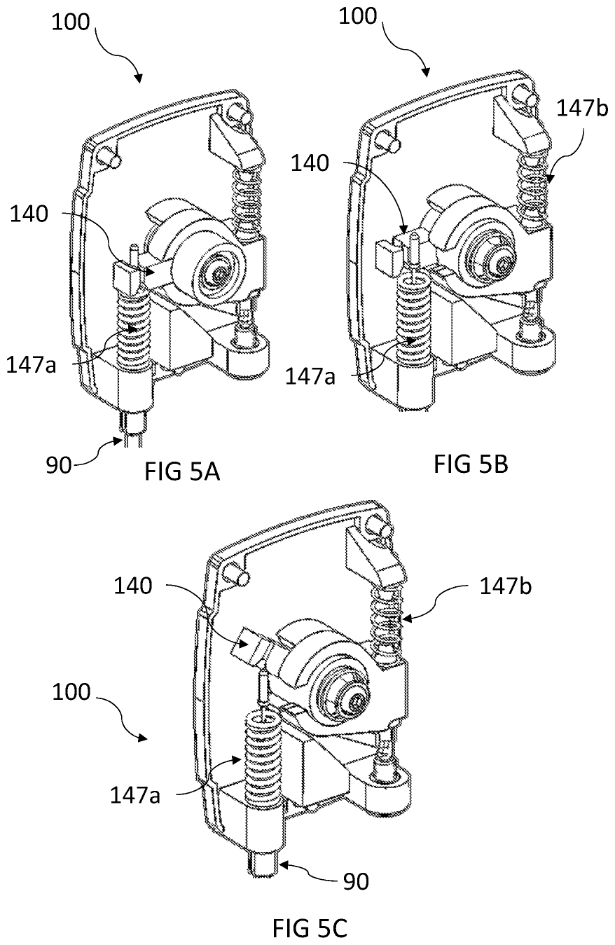

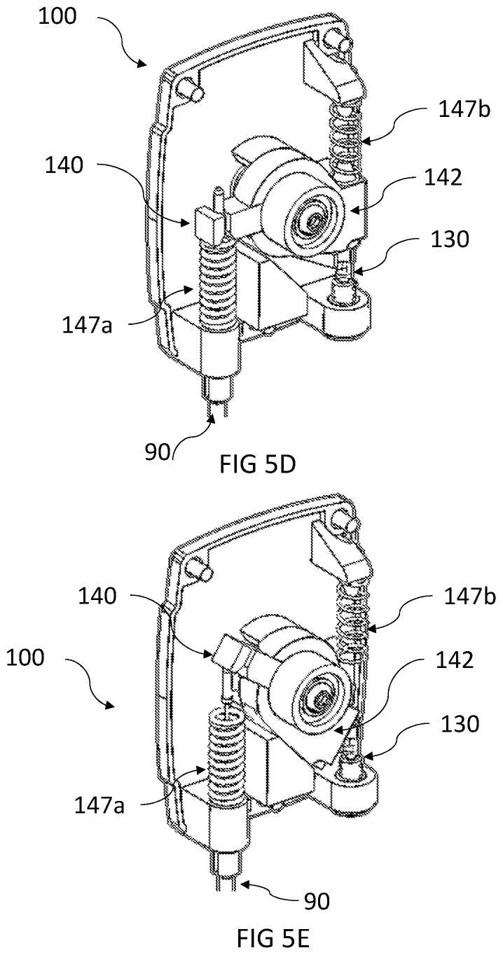

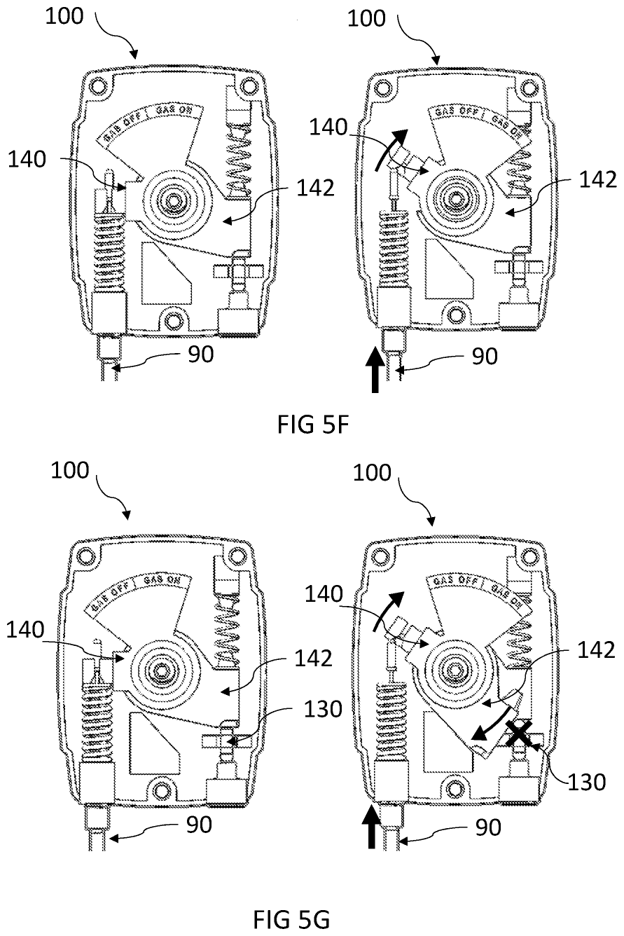

FIGS. 5A-5C show the operation of the remote actuation device 100 in response to a standard button push—the inner trigger member 140 moves axially to be released (FIG. 5B) and is then free for 1st spring 147a bias to pull on cable 90 laterally (FIG. 5C). FIGS. 5D and 5E show the operation of the remote actuation device 100 in response to heat activation. Instead of a glass bulb, a pre-tensioned heat sensitive bimetallic actuator 130 is mounted against the outer trigger member 142. The bimetallic actuator 130 flexes or otherwise changes shape when exposed to an elevated temperature (e.g. 90° C.) so that the outer trigger member 142 is released to rotate under 2nd spring 147b bias and this pulls the inner trigger member 140 with 1st spring 147a bias to pull on cable 90.

FIG. 5F shows the manual operation of FIGS. 5A-5C. The inner trigger member 140 is sprung clockwise but is held in place by a stop (not shown) on the outer trigger member 142. When the button 120 is pressed, the inner trigger member 140 depresses and clears the stop face on outer trigger member 142. This allows the inner trigger member 140 to rotate clockwise, pulling the Bowden cable 90, which triggers the actuation unit.

FIG. 5G shows the heat activation of FIGS. 5D and 5E. The outer trigger member 142 is sprung clockwise due to the spring force acting on the inner trigger member 140. When the bimetallic actuator 130 moves, the outer trigger member 142 is free to rotate, and no longer provides a stop point for the inner trigger member 140. This allows the inner trigger member 140 to rotate clockwise, pulling the Bowden cable 90, which triggers the actuation unit.

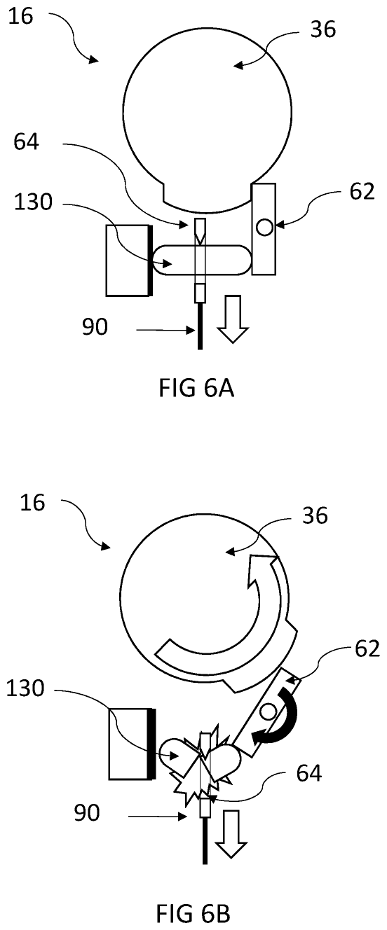

FIGS. 6A and 6B show how the other end of the Bowden cable 90 could be operable at the actuation unit 16. In this example, arbor rotation is held by an interference lever 62. A heat sensitive bulb 130 holds the rotation of the interference lever. Pulling the Bowden cable 90 deliberately smashes the bulb with a pincher/guillotine/chisel tip 64. Once the bulb is destroyed, the interference lever can rotate clockwise, releasing the arbor 36. Alternatively the Bowden cable 90 could be looped around the bulb 130. Pull on centre of bulb 130 to break (the bulbs are weak in shear).

This means the same mechanism components are used for both heat actuation and manual actuation. No trigger member or button is shown at the actuation unit, e.g. because the valve is not expected to be accessible in this example. Of course the bulb can also activate automatically, e.g. in response to heat, to operate the actuation unit.

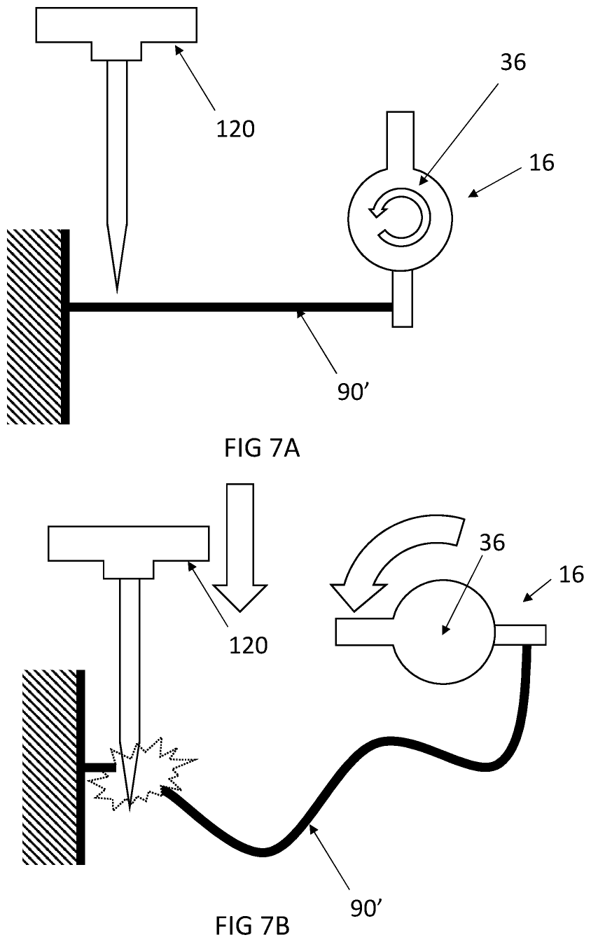

FIGS. 7A and 7B schematically illustrate how a pre-tensioned actuation cable 90′ can operate to release a latching mechanism at the actuation unit 16.

In FIG. 7A, a pre-tension is applied to the arbor 36 and resisted by the cable 90′ using for example static spring torque. In pressing the button 120 at the remote actuation device, the user breaks this cable 90′ and the arbor 36 is allowed to rotate (FIG. 7B). Although not shown, it is straightforward to include thermal actuation; either a sacrificial thermal element melts/shatters and allows the guillotine to break the cable, or the cable itself is a thermal ‘fuse’ and melts at a specific temperature.

FIG. 10 shows schematically how a Bowden cable 90, provided it is statically fixed at either end to a housing or similar, can transmit a push or a pull force 95. This can be used to directly drive the arbor 36 in the actuation unit 16. It may be desirable to include a force multiplier (gearing, lever etc.) in this drivetrain.

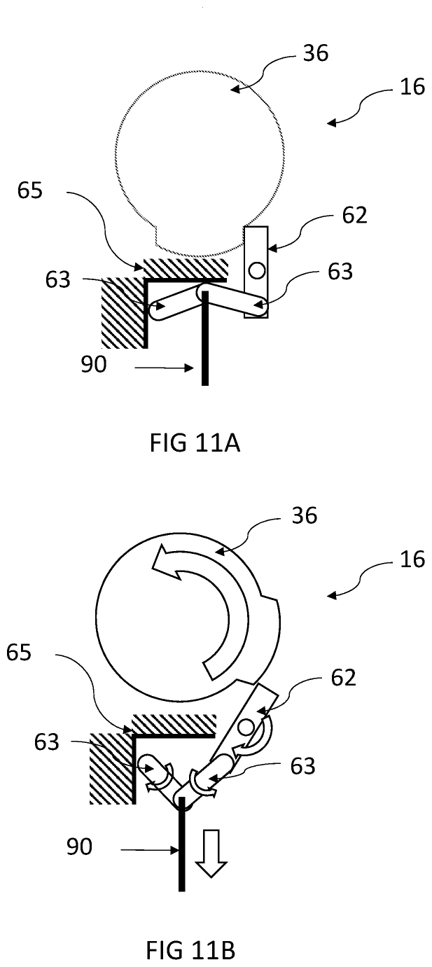

FIG. 11 shows schematically another example of how the other end of the Bowden cable 90 could be operable at the actuation unit 16. The arbor 36 is preloaded in torsion. This is reacted by an interference lever 62, held in place by a pair of jointed arms 63, arranged in an over-centre style assembly. This is prevented from over-rotation by a static ‘ground’ point 65. When the cable 90 is pulled, the arms pass their centre point. This allows the interference lever 62 to rotate, which then permits the arbor 36 rotation.

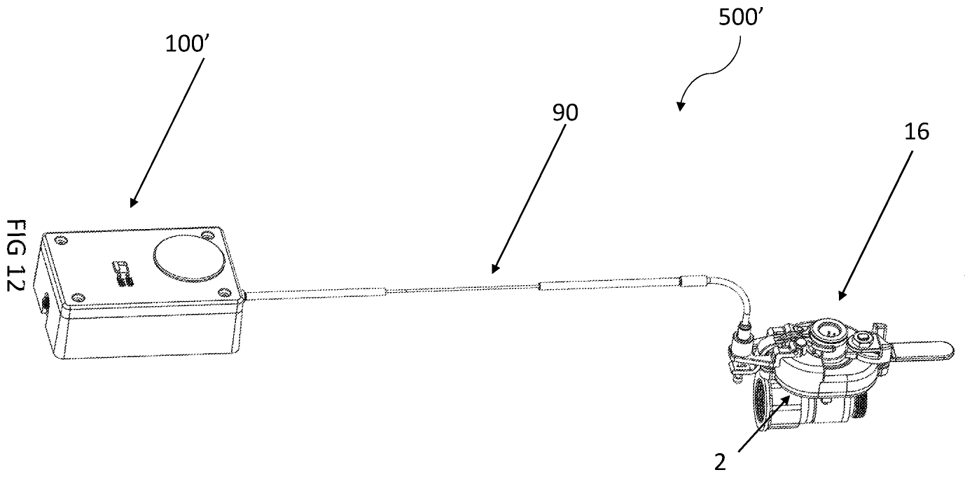

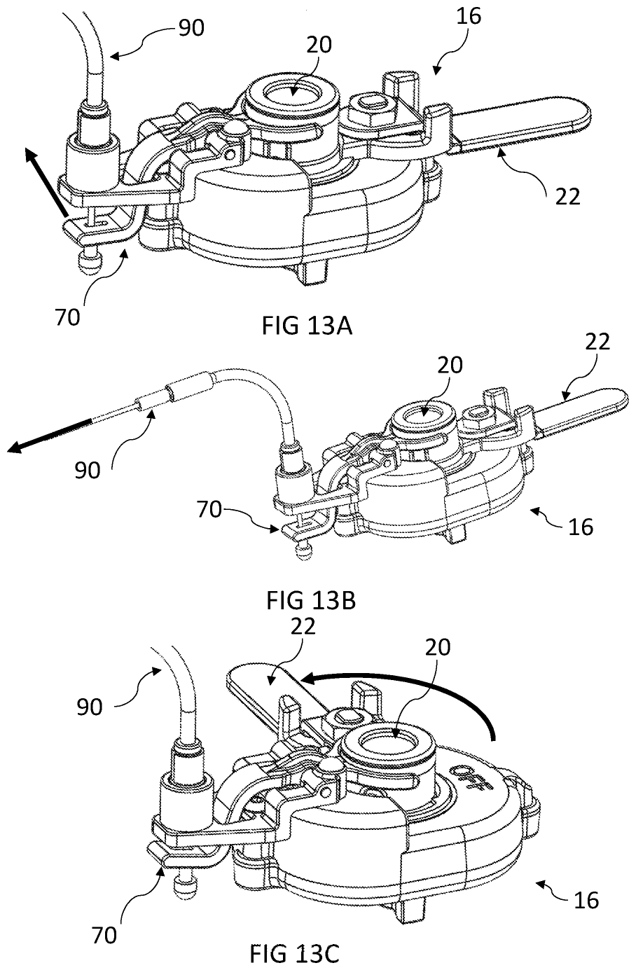

FIG. 12 is an overview of another example of an actuation system 500′ comprising a remote actuation device 100′; Bowden cable 90; and a valve assembly comprising a valve 2 and actuation unit 16. Its operation will be described with reference to FIGS. 13A-13C. As seen in FIG. 13A, pull of the Bowden cable 90 lifts one side of the hinged lever 70. As seen in FIG. 13B, the other side of the hinged lever 70 pivots down to depress the button 20. This approach uses the actuation unit's 16 own triggering mechanisms to release the torsion spring which closes the valve 2. As seen in FIG. 13C, the arbor 36 can then rotate and drive the valve 2 closed (as seen by rotation of the operating handle 22). The button 20 remains down once it is triggered. It can only return to the up position when the handle 22 is turned back. This allows the change in state to be shown at the remote actuation device 100′ (due to force transmission as illustrated by FIG. 10). When the handle 22 is returned, the button 20 lifts under the action of the button spring, pulling the Bowden cable 90 and returning the remote button into the up position.

In an alternative version of the actuation system 16, the hinged lever 70 is omitted and the Bowden cable 90 is arranged to pull the button 20 down directly.

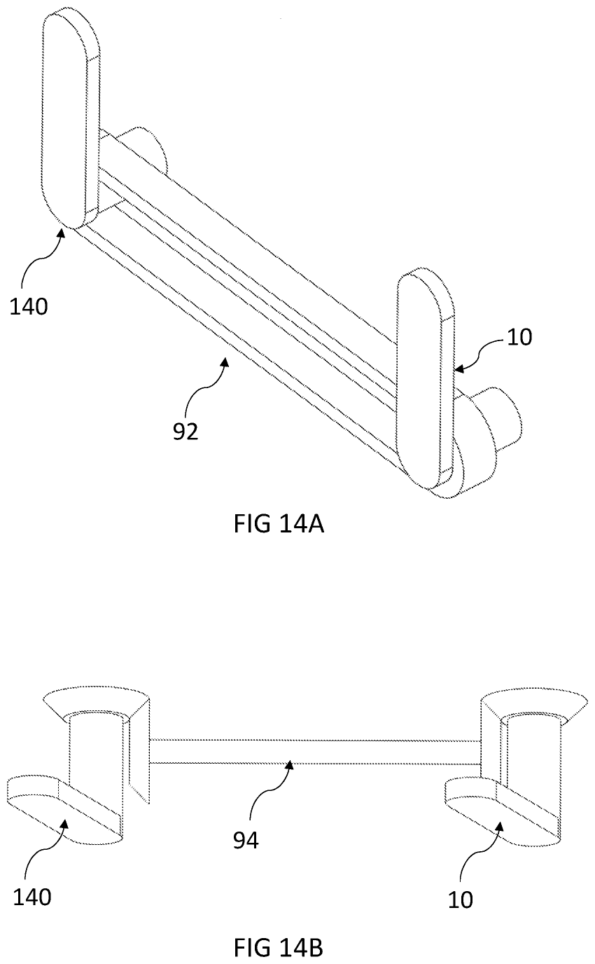

FIG. 14 shows examples of a mechanical linkage that can be used in place of a Bowden cable to transmit force both ways between the remote actuation device 100, 100′ and the actuation unit 16. This is a direct mechanical linkage between the remote (left) handle 140 and the valve (right) handle 10. This can take the form of a belt 92 (FIG. 14a), a driveshaft 94 (FIG. 14b), or intermediary levers or other common mechanical power transmission devices.

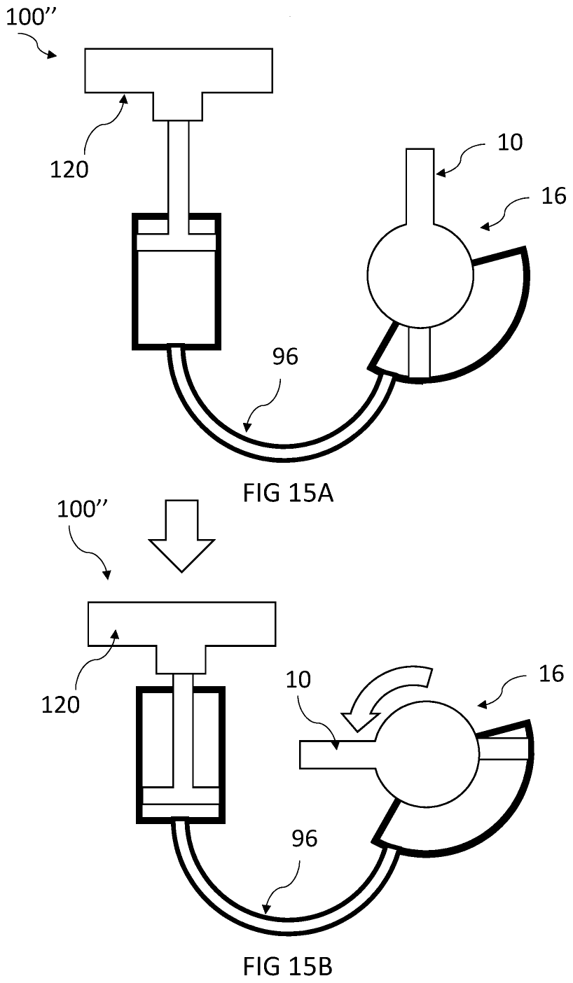

FIGS. 15A and 15B shows an example of a hydraulic linkage 96 that can be used in place of a Bowden cable to transmit force both ways between the remote actuation device 100″ and the actuation unit 16. A direct hydraulic linkage 96 can connect the actuation unit 16 to the remote actuation device 100″. Moving the valve handle 10 or the remote actuator button 120 will directly move the other end. Their relative displacements can be controlled using common hydraulic techniques such as piston diameter control.

FIG. 16 shows an example of a pneumatic linkage 98 that can be used in place of a Bowden cable to transmit force between the remote actuation device 1000 and the actuation unit 16. A manually activated valve 142 can release pressurised carbon dioxide (or similar) from a cannister 160 at the remote actuation device 1000. When the carbon dioxide valve 142 is manually activated, the bellows 72 will expand, closing the valve 2. Reset must be done at the valve and the remote actuation device 1000.

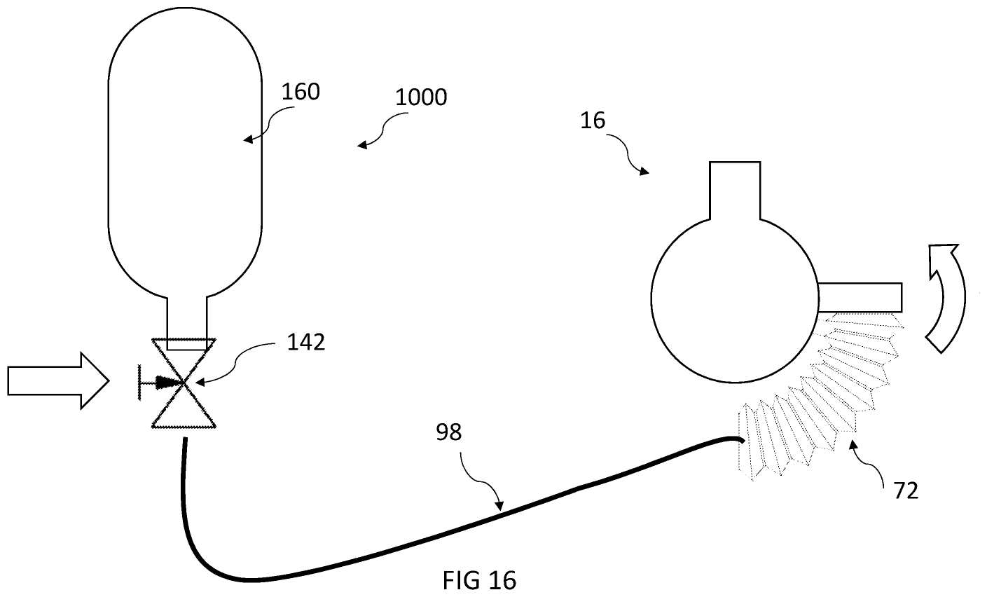

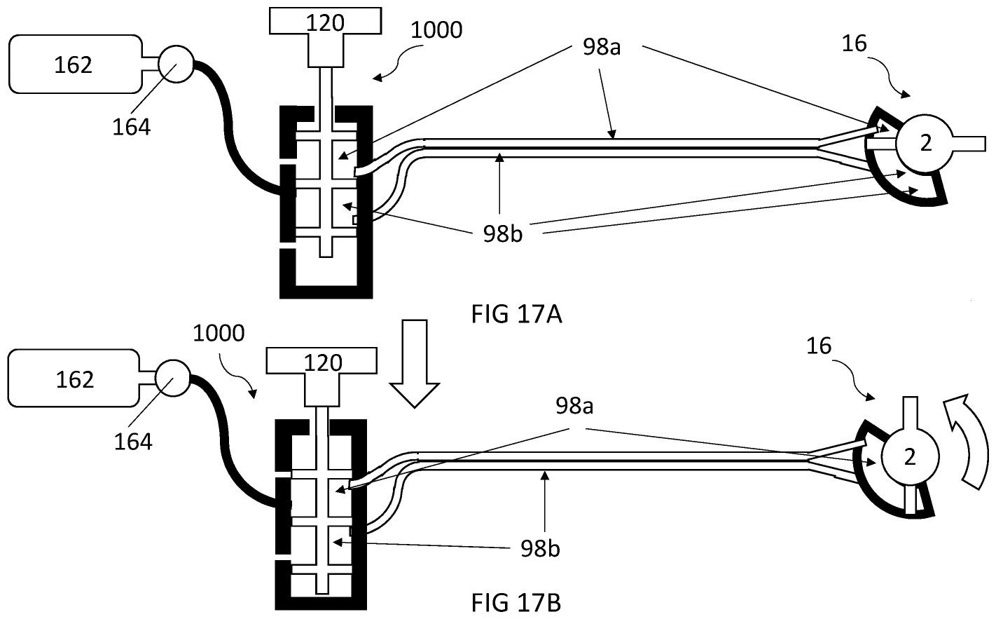

FIGS. 17A and 17B shows an example of a pneumatic linkage 98a, 98b that can be used in place of a Bowden cable for one-way force transmission between the remote actuation device 1000 and the actuation unit 16. Reset must be done at the remote actuation device 100, but can be done by returning the button 120 to its initial position. FIGS. 17A and 17B show how a high pressure storage tank/generator 162 is attached to a regulator 164, attached via the button 120 to an upper pneumatic linkage 98a and a lower pneumatic linkage 98b to the valve 2. In FIG. 17A the gas is on, the upper pneumatic linkage 98a is vented to atmosphere and the lower pneumatic linkage 98b is pressurized. When the button 120 is pressed, as shown in FIG. 17B, the upper pneumatic linkage 98a becomes pressurized, and the lower pneumatic linkage 98b is vented to atmosphere, turning the valve 2 so the gas is off.

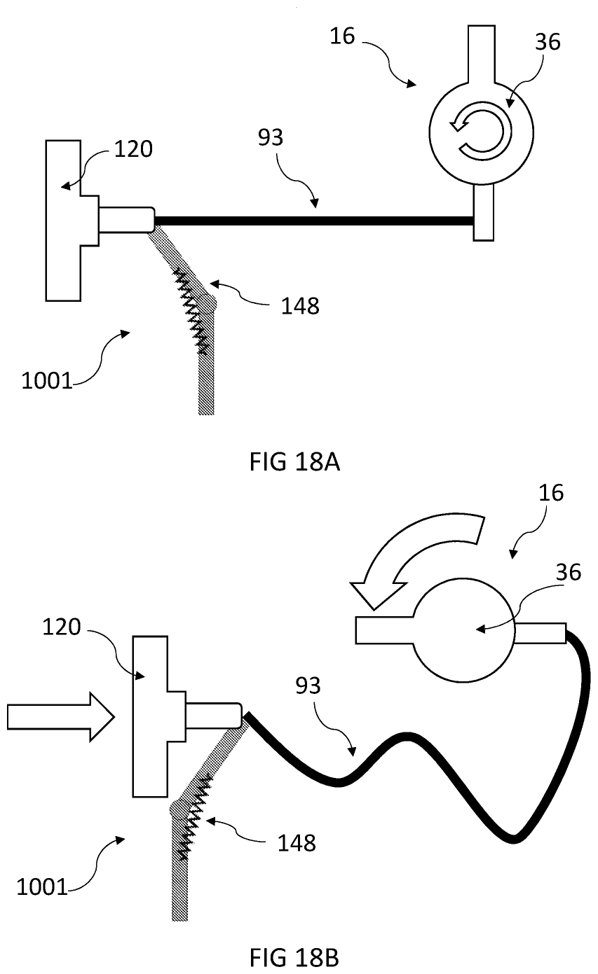

FIGS. 18A and 18B show an example of a one-way mechanical linkage that can be used in place of a Bowden cable for one-way force transmission between the remote actuation device 1001 and the actuation unit 16. A bi-stable mechanical latch 148 is used to resist the pre-tension of the static spring torque at the actuation unit 16. A user applying external force to the button 120 at the remote actuation device 1001 overcomes the latch's internal resistance and moves it; this introduces slack to the cable 93 and allows the arbor 36 in the actuation unit 16 to rotate. The bi-stable mechanical latch 148 is resettable at the remote actuation device 1001.

In any of the examples described in relation to FIGS. 7-18, an environmentally sensitive actuator 130 as previously described herein may be included as part of the actuation unit 16 and/or remote actuation unit 100, 100′.

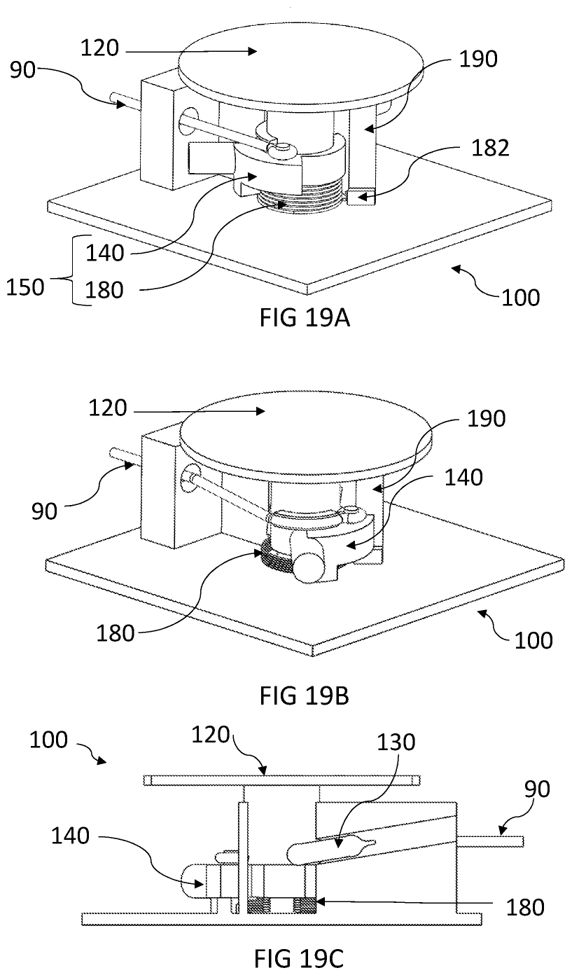

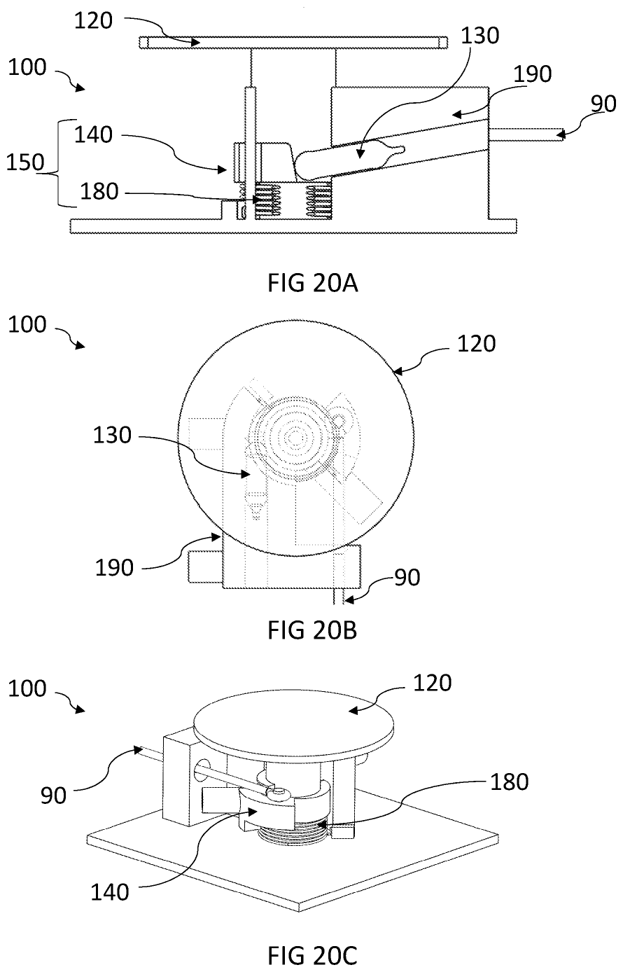

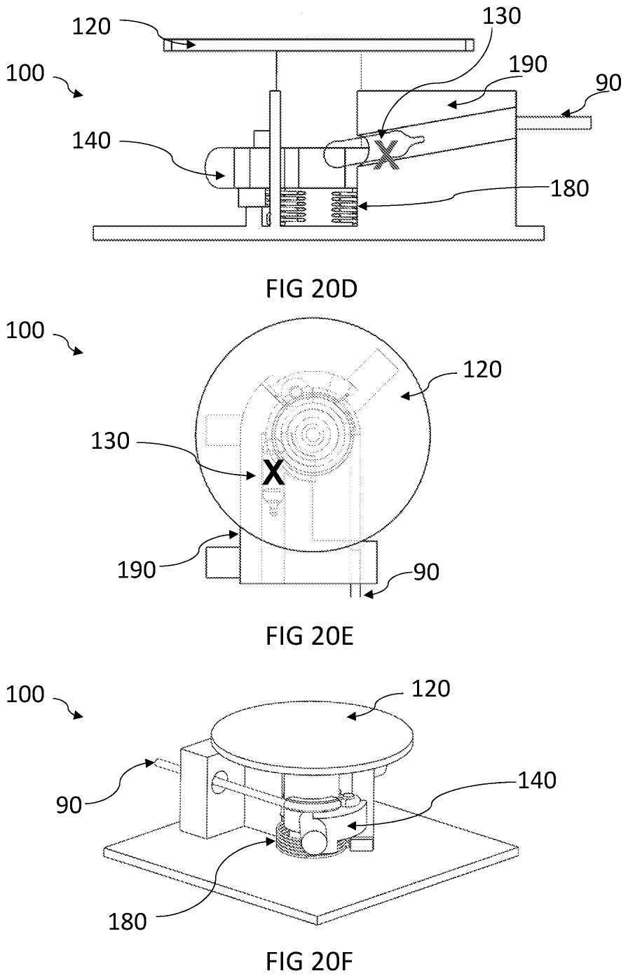

FIGS. 19A-19C and 20A-20F show views of another example remote actuation device 100 employing a remote trigger mechanism 150 to actuate the cable 90. The remote trigger mechanism comprises a single spring 180, a remote trigger member 140, and a stop to prevent rotation of the remote trigger member 140. The single spring 180 produces both linear and torsional forces (i.e. combined torsion and compression spring) to translate the pushing of the button 120 to a rotation of a remote trigger member 140 which pulls on the Bowden cable 90. FIG. 19B shows the remote actuation device 100′ when the manual input element (button) 120 is in the up position within a static housing 190. A first end 181 of the combined torsion and compression spring 180 is attached to a rotatable trigger member 140 that is coupled to one end of the Bowden cable 90, and a second end 182 is attached to the static housing 190. Button press compresses the spring 180 allowing for the torsional spring force to rotate the remote trigger member 140, pull on the Bowden cable 90 and activate the triggering mechanism of the actuation unit 16, as seen in FIG. 19B. In this example, the environmentally sensor 130 e.g. a heat activated bulb is located so as to be undisturbed by the pushing of the button 120 as shown in FIG. 19C.

FIGS. 20A-20F show the remote actuation device 100 from another perspective to show how the heat activated bulb 130 can sit and operate within the static housing 190. FIGS. 20A-20C show the remote actuation device 100 when not activated. The bulb 130 is positioned to act as a stop to prevent rotation of the remote trigger member 140. When the button 120 is pressed the spring 180 is compressed to allow rotation in a different plane to the bulb 130 as described in FIGS. 19A-19C. When the bulb 130 is broken, the spring 180 is instead free to rotate the trigger member 140 in the initial plane and hence pull on the Bowden cable 90 as shown in FIG. 20D-20F. In this scenario there is no compression of the spring 180 so the button 120 remains in the up position, the only movement is rotation of the remote trigger member 140 as shown in FIG. 20F.

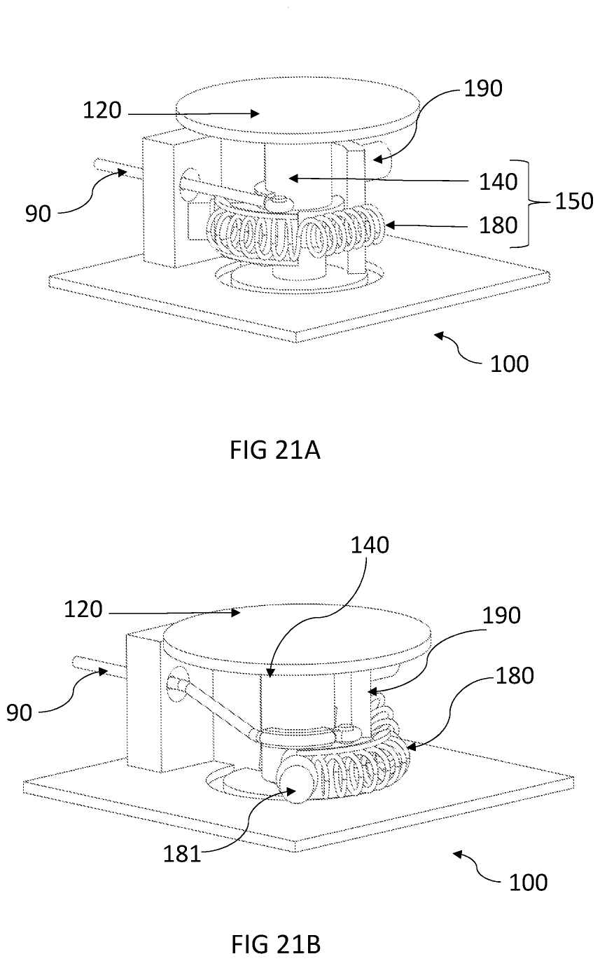

FIGS. 21A-21B show views of another remote actuation device employing a single spring 180 that is a tension spring wrapped around the remote trigger member 140 with a first end 181 attached to the remote trigger member 140, and a second end 182 attached on the static housing 190, preferably at an elevated location to provide an additional vertical force component on the button 120 to keep it in the up position unless pressed. The combination of the single spring 180 and the remote trigger member 140 acts as a remote trigger mechanism 150, in the same way as seen in FIGS. 19A-19C and 20A-20F. FIG. 21a shows the remote actuation device 100 when the button 120 is up. Button 120 press releases the spring 180 which rotates the remote trigger member 140 to pull on the Bowden cable 90 and activate the triggering mechanism of the actuation unit 16, as seen in FIG. 21B. In the same way as seen in FIGS. 20A-20F, the bulb 130 sits in a higher plane within the static housing 190 so it is undisturbed when the button 120 is pushed. When the bulb 130 breaks the remote trigger member 140 is similarly released so as to rotate the remote trigger member 140 and pull on the Bowden cable 90.

It will be appreciated that whilst FIGS. 19-21 are described with reference to a heat-activated bulb, other example environmentally sensitive actuators 130 previously described may also be used with these remote actuation devices 100, where the destruction and/or movement of the environmentally sensitive actuator 130 removes the stop, allowing for the remote trigger member 140 to rotate under a spring bias and the end of the Bowden cable 90 to be pulled.

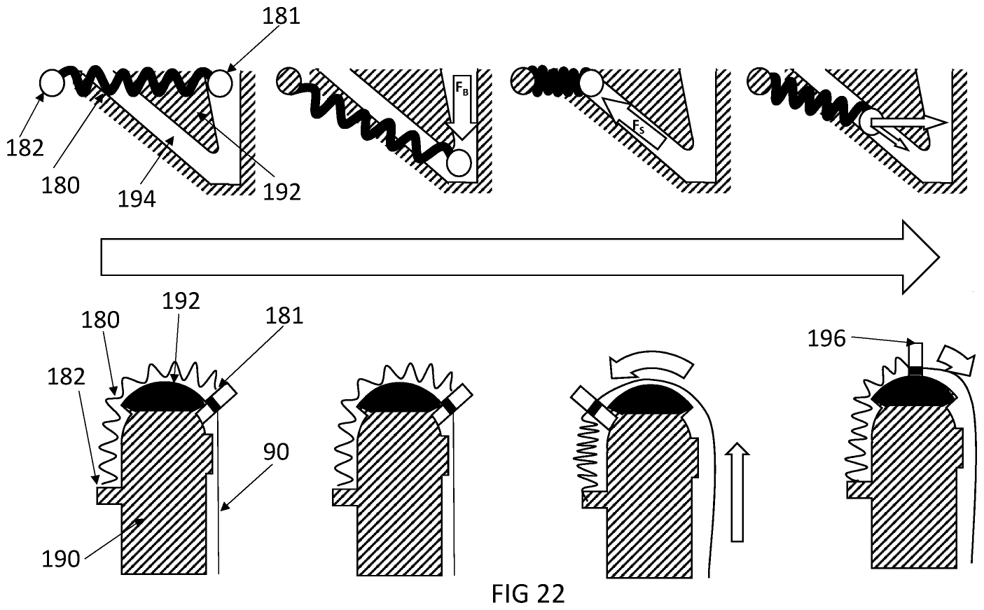

FIG. 22 is a schematic drawing of spring movement for activation and reset of the remote actuation device 100 with a single spring 180, and is applicable to either of the examples shown in FIGS. 19-21. Two perspectives are shown, a side on view, and a top down view. A first end 181 of the spring 180 is attached to the remote trigger member (button not shown), and the second end 182 of the spring 180 is attached to a stationary point on the static housing 190. A force applied to the button FB drives the first end 181 of the spring 180 downwards. The spring force Fs then pulls the first end 181 of the spring 180 further along the channel 194 to move the remote trigger member 140. The system can be reset by applying a torque ramping the first end 181 of the spring 180 down the channel 194 until the corner is reached, e.g. by twisting a manual input element (e.g. button) coupled to the remote trigger member 140. The vertical component of the spring force then returns the button 120 to the original position. The torque can be applied directly to the button 120, to an additional reset member 194 coupled to the remote trigger member 140, or via a two-way actuation cable or other linkage (e.g. a Bowden Cable), allowing the entire system to be reset when the valve 2 is opened. The environmentally sensitive actuator 130 can be located as shown so as to remove the stop 192 which keeps the spring 180 in its initial position, releasing the spring 180 without the button 120 being pressed. The mechanism is shown to have a rotational actuation path but equally could be realised in a purely linear fashion.

Whilst FIGS. 19-22 have been described with reference to a push of the button 120 pulling on the Bowden cable 90, it will be appreciated that the mechanism could easily be adapted to a push of the button 120 pushing the Bowden cable 90. The position of the button 120 and the direction of movement of the Bowden cable 90 can be designed in any suitable manner for actuating a valve to open and close.

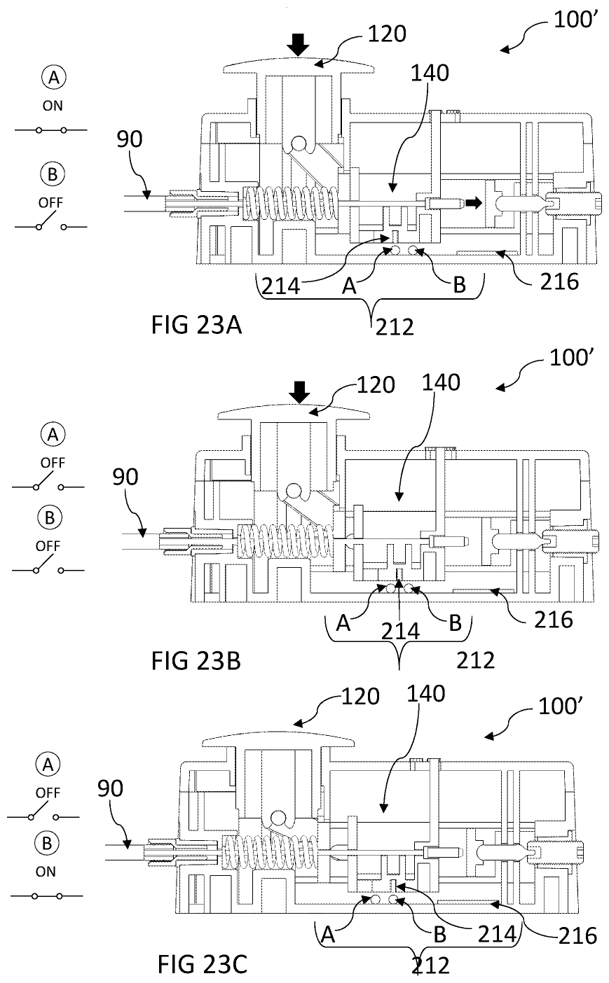

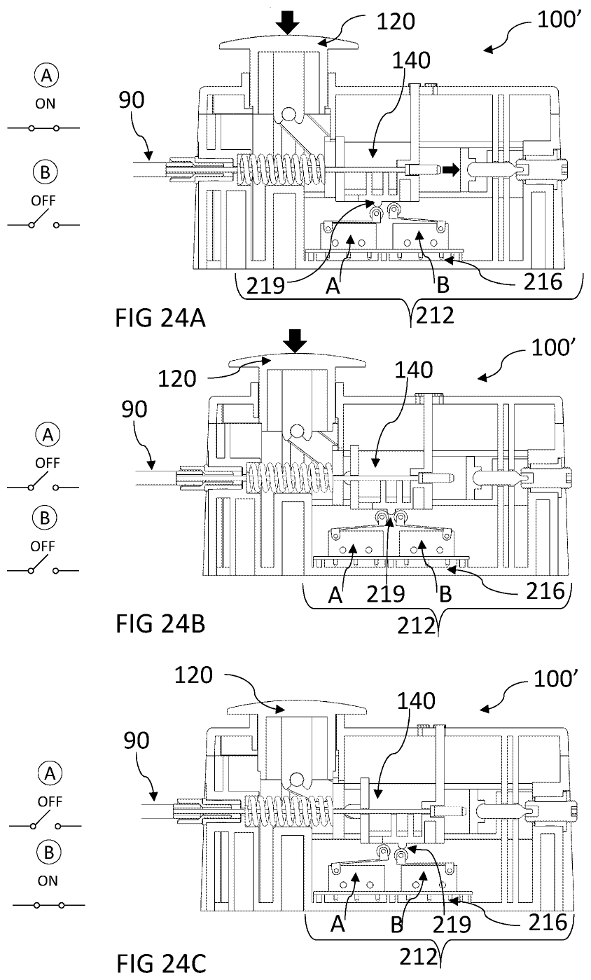

It can be desirable to electrically sense the state of the remote actuation device 100 and/or Bowden cable 90 so as to enable external monitoring without being present to view a visual indicator 125 (or the like) at the remote actuation device 100. Such monitoring can be applied to any of the previously described example remote actuation devices. For example, electrical monitoring can be implemented into the remote actuation device 100 of FIG. 3, where the trigger member 140 is an inner sliding carriage. This is described below in relation to FIGS. 23-24.

FIGS. 23A-23C show the remote actuation device 100′ including a state sensing arrangement 212 for detecting movement of the inner carriage 140 (i.e. the remote trigger member) between a first position corresponding to the actuation cable being unoperated (FIG. 23A) and a second position corresponding to the actuation cable being operated (FIG. 23C). This state sensing arrangement 212 comprises two electromagnetic sensing points A and B, corresponding to the first and second positions respectively, a magnet 214 mounted to the remote trigger member 140 (i.e. the inner carriage), and a processing unit 216 (e.g. mounted on a PCB as shown). FIG. 23A shows the remote actuation device 100′ when the valve is open, where the switch at point A is in the ON position, and the switch at point B is in the OFF position. When the button is pressed and the Bowden cable 90 is pulled by the remote trigger member 140 as previously described, the movement of the magnet 214 allows switch A to turn OFF. As this stage both switches are OFF as shown in FIG. 23B. When the movement of the remote trigger member 140 is completed and the Bowden cable 90 has been pulled to reach its fullest extent, switch B is opened by the magnet 214 as shown in FIG. 23C; this represents the position when the valve is fully closed.

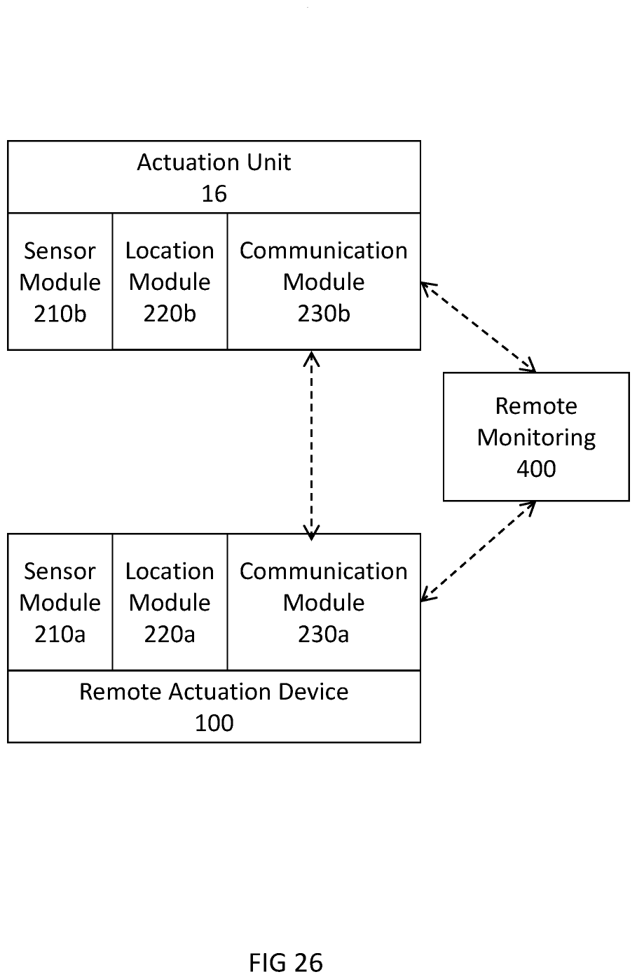

Whilst this example shows the magnet underneath the inner carriage 140, a skilled person can appreciate how the magnet 214 could be placed on any of the moving parts of the remote actuation device 100 which would allow the two (preferably three) states to be monitored, for example on the end of the Bowden cable 90 or mounted to the remote trigger member 140 (e.g. mounted in or on the sliding carriage). Various types of switch or sensor could be utilized, for example Reed switches or Hall-Effect sensors. The placement of the switches/sensors will depend on the strength of the magnet 214 and the type of switch or sensor utilized. In this example the processing unit 216 is placed separately from the switches within the housing of the remote actuation device, however the processing unit 216 can be placed in any reasonable location to connect to the switches A and B. The processing unit 216 and the state sensing arrangement 216 may be provided as part of an electrical sensor module 210 configured to produce electrical signals corresponding to the detected state. As is described further below in relation to FIG. 26, such a sensor module 210 may be connected to (or integrated with) a communications module 230 so that the detected state signals can be transmitted to an external entity for remote monitoring purposes.

As an alternative to electromagnetic sensing, other electronic sensing embodiments may be used such as optical sensors etc.

FIGS. 24A-24C show the remote actuation device 100′ employing another example of a state sensing arrangement 212, in this case utilizing electromechanical switches. Two micro switches A and B are placed beneath the sliding inner carriage 140 at a first and second position respectively and a mechanical interface 219 is provided on the underside of the inner carriage 140 to trigger the switches at the desired positions. FIG. 24A shows the remote actuation device 100 and switch status when the valve 2 is open, FIG. 24B shows the circuit status when in transit, and FIG. 24C shows the remote actuation device 100 and switch status when the valve 2 is closed. The electromechanical switches in FIGS. 24A-24C switch on and off in the same way as the electromagnetic switches described with reference to FIGS. 23A-23C.

Whilst a sensor module 210 with a single switch or sensor can be employed, it is preferred to use a combination of two switches as shown in FIGS. 23 and 24 which advantageously allows three states to be monitored, a first state corresponding to the valve being open, a second state corresponding to the valve 2 being closed, and a third state indicating an “in transit” state. This allows for accurate monitoring of the remote actuation device 100 in case the valve has not been fully closed.

It will be appreciated that whilst FIGS. 19-24 are described with reference to a Bowden cable 90, any other two-way force transmission cable may be used, and any of the previously described mechanical linkages may also be suitably used with these example remote actuations devices 100,

In addition to a state sensing arrangement 212 at the remote actuation device 100′, or alternatively, the actuation unit 16 may comprise a state sensing arrangement 212 for detecting a rotational position of the operating member 10 (e.g. valve stem 11).

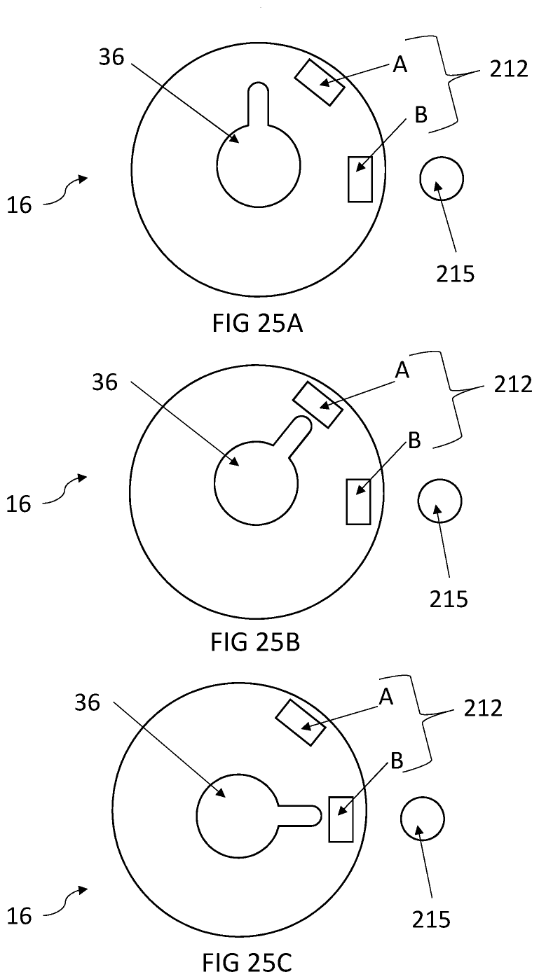

FIGS. 25A-25C show the actuation unit 16 (e.g. as already described above with reference to FIGS. 8-9) employing an example state sensing arrangement 212 in a similar manner to the remote actuation device 100′ described in relation to FIGS. 23-24. Two sensors are placed relative to the valve arbor 36 which will show three states. FIG. 25A shows a first state (i.e. valve open), FIG. 25B shows the third state (i.e. “in transit”), and FIG. 25C shows the second state (i.e. valve closed). Alongside the valve assembly is shown an indicator 215, which responds to the sensors to show the state of the valve 2. This indication can be via a colour indicator light (showing for example green for open, orange for in transit, and red for closed), or a digital display.

It will be appreciated that the various state sensing arrangements 212 described in FIGS. 23-25 can be easily adapted to any of the other example remote actuation devices 100, 100′, 100″, 1000, 1001 and actuation units 16 previously described. For example, in those remote actuation devices 100 comprising a rotating trigger member instead of a sliding carriage, the state sensing arrangement 212 may detect the rotational position of the remote trigger member 140 rather that its translation as seen in FIGS. 23-24, but otherwise the same principles apply.

In any example where the remote actuation device 100, 100′, 100″, 1000, 1001 and/or the actuation unit 16 comprises a state sensing arrangement 212, this may be provided as part of a sensor module 210 including a processor 216 configured to process the electrical signals corresponding to the detected state. As is described further below in relation to FIG. 26, such a sensor module 210 may be connected to (or integrated with) a communications module 220 so that the state signals can be transmitted to an external entity for remote monitoring purposes.

FIG. 26 shows a schematic diagram for wireless monitoring of the actuation system 500. In this example both the actuation unit 16 and the remote actuation device 16 have sensor module 210, location modules 220 and communication modules 230. In another example only one of the actuation unit 16 or the remote actuation device 100 has the sensor 210, location 220 and communication modules 220. The sensor modules 210a, 210b include the state sensing arrangements 212 as described with reference to FIGS. 23-25, which may be installed on the actuation unit 16 and/or the remote actuation device 100 along with communication modules 230a, 230b. The location modules are optional or alternative to the sensor modules.

The communication modules 230a, 230b can send information from the sensor modules 210a, 210b relating to the status of the actuation system 500 either to another communication module 230a, 230b or to a remote monitoring station 400. Communication from the actuation unit 16 to the remote actuation device 100 can confirm that the status at the valve 2 is the same as the valve status indicated the remote actuation device 100. The communication module 230a, 230b can use long or short range wireless communication protocols. Short-range wireless protocols may be employed for communication between the actuation unit and the remote actuation device using for example Bluetooth or WiFi. When using short-range wireless protocols, the actuation system 500 may connect to a local internet hub (e.g. a home network) to send monitoring details for remote monitoring. Preferably the communication modules 230a, 230b implement long-range wireless protocols to send data to a remote monitoring location, e.g. via an integrated SIM card.

The communication modules 230a, 230b may also (or alternatively) send information about the location of remote actuation device 100 and/or actuation unit 16 to the remote monitoring station 400. Location information may be GPS information, or pre-programmed location information including information on how to locate the remote actuation device 100 and/or actuation unit 16. The location modules 220a, 220b may be able to emit a visual and/or an audible cue that can be activated from the remote monitoring station 400 to aid a user in locating the remote actuation device 100. The visual and/or an audible cue may change depending on the status of the valve. Location information may be stored locally at the remote actuation device 100 and/or actuation unit 16 and/or location information may be stored at the remote monitoring location 400. The remote monitoring location 400 may be a centralised location e.g. a gas supplier, or be a user's or technician's mobile device.

It will be apricated by the skilled person that all electrical components at the remote actuation device 100 and the actuation unit 16 would need to be intrinsically safe (i.e. ATEX rated) due to the potential dangers of leaks from the valve (e.g. a gas leak).

Whilst the example of FIG. 26 shows sensor modules 210a, 210b, a location modules 220a, 220b, and communication modules 230a, 230b, it will be understood that various combinations of these features are also possible e.g. just a sensor module 210a, 210b, or a sensor module 210a, 210b but no location module 220a, 220b.

What is claimed is:

1. An actuation system for a valve assembly, the actuation system comprising:
an actuation unit arranged to engage with an operating member of a valve to drive rotation of the operating member; and
a remote actuation device arranged at a distance from the actuation unit and coupled to the actuation unit by an actuation cable, the actuation cable being operable to engage the actuation unit to drive rotation of the operating member;
wherein the actuation system further includes an environmentally sensitive actuator arranged to operate the actuation cable; and
wherein the remote actuation device includes a manual input element designed to receive a specific manual input, the manual input element arranged to operate the actuation cable in response to the specific manual input.

2. The actuation system of claim 1, wherein the actuation cable can be operated by the manual input element to release the operating member independently of activation of the environmentally sensitive actuator.

3. The actuation system of claim 1, wherein the actuation cable can be operated multiple times by the manual input element with the remote actuation device being reset after each operation.

4. The actuation system of claim 1, wherein the remote actuation device comprises a remote trigger member coupled to an end of the actuation cable and arranged to be operated by the environmentally sensitive actuator and/or by the manual input element.

5. The actuation system of claim 4, wherein the remote actuation device comprises a spring arranged to bias the remote trigger member to operate the actuation cable and wherein the environmentally sensitive actuator is arranged to hold the remote trigger member against the bias; and preferably,
wherein when the environmentally sensitive actuator is activated, the spring is free to bias the remote trigger member and thereby operate the actuation cable.

6. The actuation system of claim 4, wherein the manual input element is arranged to act independently on the remote trigger member.

7. The actuation system of claim 6, wherein the manual input element is coupled to the remote trigger member such that operation of the remote trigger member by the environmentally sensitive actuator also moves the manual input element.

8. The actuation system of claim 7, wherein the manual input element is locked in the OFF state until the valve is opened and the environmentally sensitive actuator is reset or replaced.

9. The actuation system of claim 1, wherein the actuation cable is a force transmission cable, optionally wherein the actuation cable is a two-way force transmission cable.

10. (canceled)

11. The actuation system of claim 1, wherein
the remote actuation device comprises a remote indicator coupled to the actuation cable such that operation of the actuation cable changes the valve status at the remote indicator.

12. The actuation system of claim 1, wherein
the actuation cable is arranged to transmit a reset force to the remote actuation device to reset the manual input element when the valve at the actuation unit is reset.

13. The actuation system of claim 4, wherein the remote actuation device comprises a remote indicator coupled to the remote trigger member.

14. The actuation system of claim 13, wherein the remote actuation device comprises a visual indicator coupled to the remote trigger member to remotely indicate when the valve is in the open position and when the valve is in the closed position; and optionally,
wherein a first visual marker indicates the open position and a second visual marker indicates the closed position.

15. The actuation system of claim 1, wherein the remote actuation device includes a locking mechanism arranged to disable the manual input element when the environmentally sensitive actuator is activated to operate the actuation cable.

16. (canceled)

17. The actuation system of claim 1, wherein the remote actuation device comprises a sensor module for detecting movement of the actuation cable or linkage between a first state corresponding to the actuation cable being unoperated and a second state corresponding to the actuation cable being operated.

18. (canceled)

19. The actuation system of claim 17, wherein the remote actuation device comprises a communications module for transmitting status information relating to the detected state.

20. The actuation system claim 17, wherein the remote actuation device comprises a remote indicator for displaying status information relating to the detected state.

21-26. (canceled)

27. The actuation system of any preceding claim 1, wherein the valve is a gas supply valve and the environmentally sensitive actuator is arranged to operate the actuation cable or linkage in response to one or more of: elevated heat, elevated pressure, fire, or smoke; or
wherein the valve is a water supply valve and the environmentally sensitive actuator is arranged to operate the actuation cable or linkage in response to flood or freezing conditions; or
wherein the valve is a water control valve and the environmentally sensitive actuator is arranged to operate the actuation cable or linkage in response to one or more of: elevated heat, elevated pressure (e.g. explosion), fire, or smoke.

28-43. (canceled)

44. An actuation system for a valve assembly, the actuation system comprising:
an actuation unit arranged to engage with an operating member of a valve to drive rotation of the operating member; and
a remote actuation device arranged at a distance from the actuation unit and coupled to the actuation unit by an actuation cable or linkage, the actuation cable being operable to engage the actuation unit to drive rotation of the operating member;
wherein the remote actuation device includes a manual input element and a remote trigger mechanism arranged to operate the actuation cable or linkage;
wherein the manual input element is a push button and the remote trigger mechanism is arranged to convert an axial movement of the push button into a rotational movement that operates the actuation cable or linkage.

45. An actuation system for a valve assembly, the actuation system comprising:
an actuation unit arranged to engage with an operating member of a valve to drive rotation of the operating member; and
a remote actuation device arranged at a distance from the actuation unit and coupled to the actuation unit by an actuation cable, the actuation cable being operable to engage the actuation unit to drive rotation of the operating member;
wherein the actuation system further includes an environmentally sensitive actuator arranged to operate the actuation cable;
wherein the remote actuation device includes a manual input element arranged to operate the actuation cable;
wherein the remote actuation device comprises at least one remote trigger member coupled to an end of the actuation cable; and
wherein the at least one remote trigger member is arranged to be operated by the environmentally sensitive actuator and arranged to be operated by the manual input element.
